(19) United States
(12) Patent Application Publication
(10) Pub. No.: US 2017/0137684 A1
(43) Pub. Date: May 18, 2017

(54) CRYSTALS FOR COOLING SOLUTIONS AND RELATED METHODS

(71) Applicant: University of Washington, Seattle, WA (US)

(72) Inventors: Peter Pauzauskie, Seattle, WA (US); Paden Roder, Seattle, WA (US); Bennett Smith, Seattle, WA (US); Xuezhe Zhou, Seattle, WA (US)

(73) Assignee: University of Washington, Seattle, WA (US)

(21) Appl. No.: 15/351,352

(22) Filed: Nov. 14, 2016

Related U.S. Application Data
(60) Provisional application No. 62/255,183, filed on Nov. 13, 2015.

(51) Int. Cl. C09K 5/10; F25B 23/00; C09K 11/77

(52) U.S. Cl. CPC C09K 5/10; C09K 11/7791; F25B 23/00

(57) ABSTRACT

The present disclosure relates crystals capable of cooling upon illumination. In certain embodiments, the crystals include yttrium-fluoride doped with a trivalent rare earth ion. Exemplary crystals include yttrium-lithium-fluoride crystals and yttrium-sodium-fluoride crystals, doped with Yb³⁺, Er³⁺, or a combination of both. Methods of producing the crystals hydrothermally and methods of cooling a solution are also provided. Further methods include use of the crystals for therapeutic hypothermia. Finally, a theranostic is provided that includes the crystals conjugated to a targeting moiety capable of selectively binding to a target.

### CROSS-REFERENCE TO RELATED APPLICATION

This application claims the benefit of U.S. Provisional Application No. 62/255,183, filed on Nov. 13, 2015, the disclosure of which is hereby expressly incorporated by reference in its entirety.

### STATEMENT OF GOVERNMENT LICENSE RIGHTS

This invention was made with U.S. government support under grant number FA95501210400, awarded by Air Force Office of Scientific Research, and under grant number DGE1256082, awarded by the National Science Foundation. The U.S. Government has certain rights in the invention.

### BACKGROUND

Coherent laser radiation has enabled many scientific and technological breakthroughs including Bose-Einstein condensates, ultrafast spectroscopy, super-resolution optical microscopy, photothermal therapy, and long-distance telecommunications. However, it has remained a challenge to refrigerate liquid media (including physiological buffers) during laser illumination due to significant background solvent absorption and the rapid (˜ps) non-radiative vibrational relaxation of molecular electronic excited states.

Advances in cryogenic sciences have enabled several observations of new low-temperature physical phenomena including superconductivity, superfluidity, and Bose-Einstein condensates. Heat transfer is critical in numerous fields of science and technology including thermal management within integrated microelectronics, photonic and microfluidic circuits, and the regulation of metabolic processes. In 1929, Pringsheim proposed that solid-state materials could experience refrigeration if they exhibited biased emission of anti-Stokes (blue-shifted) radiation relative to a fixed optical excitation wavelength. Epstein and colleagues experimentally demonstrated this concept first in 1995 using rare-earth-doped fluoride glass materials (ZBLAN). Optical refrigeration of a condensed phase with a rhodamine dye by anti-Stokes radiation has previously been reported but the results remain controversial. More recently, it has been shown that rare-earth-doped lithium yttrium fluoride (Yb³⁺:YLF) crystals grown in high-temperature Czochralski reactors can be cooled to cryogenic temperatures (˜90K) in vacuo using a continuous-wave NIR laser excitation. Furthermore, the laser refrigeration of doped yttrium aluminum garnet (Yb³⁺:YAG) materials has recently been reported in air at atmospheric pressure. Anti-Stokes photoluminescence has also been reported to cool cadmium sulfide (CdS) nanoribbons in vacuo by as much as 40° C. below room temperature. In contrast to anti-Stokes processes, optomechanical laser refrigeration has also been demonstrated based on a novel mechanism of angular momentum transfer between a circularly polarized laser and a birefringent crystal.

Laser-refrigeration of nanocrystals in aqueous media is a complex problem, stemming primarily from the large near-infrared (NIR) optical absorption coefficient of water (α_{H}2O|975ₙₘ˜0.5/cm). It has remained an open question whether cooling materials could act to refrigerate aqueous media and undergo hypothesized cold Brownian motion, or whether solvent heating from the background absorption coefficient of water would overwhelm the cooling of individual crystals. Development of improved materials for laser refrigeration in solution (e.g., aqueous media) is therefore considered desirable, yet difficult to achieve.

### BRIEF DESCRIPTION OF THE DRAWINGS

The patent or application file contains at least one drawing executed in color. Copies of this patent or patent application publication with color drawings will be provided by the Office upon request and payment of the necessary fee.

The embodiments disclosed herein will become more fully apparent from the following description and appended claims, taken in conjunction with the accompanying drawings.

FIGS. 1A-1F. Synthesis and characterization of YLF crystals. (FIG. 1A) Schematic of Scheelite crystal structure of YLF with I_{41/α} space group symmetry. (FIG. 1B) Scanning electron microscope image of a faceted (Yb³⁺)_{0.1}(Y³⁺)_{0.9}LiF₄ particle exhibiting TTB morphology. Scale bar=1 μm. (FIG. 1C) Powder x-ray diffraction pattern of YLF crystals following hydrothermal synthesis indicating a pure Scheelite crystal phase. Inset: schematic of TTB morphology relative to YLF's unit cell. (FIG. 1D) Bright field transmission electron microscope (TEM) image of an individual Yb³⁺:YLF grain; scale bar=200 nm. Inset: high-resolution TEM image taken from the indicated region; scale bar=2 nm. (FIG. 1E) High-angle annular-dark-field (HAADF) image of the YLF grain in panel B showing regions of high contrast suggesting the presence of polycrystalline domains. Inset: select area electron diffraction from the indicated region. (FIG. 1F) X-ray fluorescence compositional-analysis-spectrum of an individual YLF crystal taken within the TEM confirming the elemental crystalline composition including Y, Yb, and F species.

FIG. 2. Schematic of laser trapping instrument. An optically trapped YLF crystal in an aqueous fluid chamber. A piezostage driven at 32 Hz produces a peak in the quadrant photodiode (QPD) power spectrum which is used to extract a calibrated diffusion constant. The particle's temperature (Tₚ) and local temperature profile is then extracted using cold Brownian motion analysis.

FIGS. 3A-3C. Laser refrigeration of optically trapped YLF microcrystals. (FIG. 3A) Optical micrograph of an optically trapped YLF crystal; scale bar=3 μm. (FIG. 3B) Crystal field energy level configuration of Yb³⁺ dopant ions and employed cooling scheme. (FIG. 3C) Extracted temperature (Tₚ) of optically trapped particles in D₂O as determined using the outlined CBM analysis. Yb³⁺-doped YLF particles are shown to cool when trapping wavelength is resonant with the E4-E5 transition (λ=1020 nm) but heat when the trapping wavelength is below the transition (λ=1064 nm).

FIGS. 4A-4D. Upconversion and ratiometric thermometry of codoped YLF. (FIG. 4A) Bright-field optical micrograph showing a codoped 2% Er³⁺, 10% Yb³⁺:YLF particle in Brownian motion (top-left) and a dark-field optical micrograph of the crystal when trapped with λ=1020 nm (bottom-left). Scalebar=4 μm. Upconverted photoluminescence can be seen with the unaided eye (right). (FIG. 4B) Photoluminescence spectra of the corresponding dark-field image showing the integration regions I₂ and I₁, representing emission from Er³⁺ energy states E₂ (²H_{11/2}) and E₁ (⁴S_{3/2}) to the ground state E_{ground} (⁴I_{15/2}), respectively. (FIG. 4C) Natural logarithm of the ratio I₂/I₁ showing a linear increase (top) with laser irradiance at λ=975 nm and a linear decrease (bottom) with laser irradiance at λ=1020 nm. (FIG. 4D) Laser refrigeration of the codoped YLF crystal analyzed in C measured via cold Brownian motion analysis.

FIGS. 5A-5D: Synthesis and characterization of NaYF₄ nanowires. (FIG. 5A) Schematic of hexagonal crystal structure of β-NaYF₄ with P6₃/m space group symmetry. (FIG. 5B) SEM image of β-NaYF₄:10% Yb³⁺ nanowires, scale bar=500 nm. Inset: SEM image of a β-NaYF₄:10% Yb³⁺ nanowire exhibiting an (001) end facet; scale bar=100 nm. (FIG. 5C) X-ray fluorescence compositional-analysis-spectrum of an individual β-NaYF₄:10% Yb³⁺ nanowire taken within the TEM confirming the elemental crystalline composition including Y, Yb, and F. (FIG. 5D) Bright field TEM image of β-NaYF₄:10% Yb³⁺ nanowire; scale bar=25 nm. Top inset: high-resolution TEM image taken from the indicated region; scale bar=4 nm. Bottom inset: select area electron diffraction from the indicated region.

FIGS. 6A-6G: Laser heating/cooling of single β-NaYF₄ nanowire in D₂O. (FIG. 6A) Optically-trapped β-NaYF₄ nanowire in an aqueous fluid chamber. (FIG. 6B) Top: Optical micrograph of single β-NaYF₄ nanowire before trapping. Bottom: Single β-NaYF₄ nanowire trapped in D₂O, scale bar=1 μm. (FIG. 6C) Photoluminescence from single trapped β-NaYF₄:10% Yb nanowire in D₂O before and after doping Er³⁺ ions showing cation exchange, inset: integrated PL intensity versus time plot from a trapped Er³⁺ doped β-NaYF₄ nanowires shows a decreasing trend. (FIG. 6D) Crystal field energy level configuration of Yb³⁺ dopant ions in β-NaYF₄ hexagonal structure, which shows the heating mechanism with different laser wavelengths. (FIG. 6E) Temperature of single trapped β-NaYF₄ nanowire with different Yb³⁺ dopant concentrations under both 975 nm and 1,064 nm laser irradiance. (FIG. 6F) Diagram of the anti-Stokes laser refrigeration process. (FIG. 6G) Temperature change of individually trapped β-NaYF₄ nanowires with different Yb³⁺ dopant concentrations under increasing 1,020 nm laser irradiance. Error bars are based on standard deviation of ten samples.

FIGS. 7A-7C: Comparison of calculated values for the normalized electromagnetic source term (E₁·E₁*)/E₀² for β-NaYF₄ nanowires in water with 1,020 nm laser wavelength. (FIG. 7A) Plot of the calculated maximum source term values for β-NaYF₄ nanowires with laser incidence perpendicular to the edge as a function of the hexagonal edge length ranging from 10 nm to 5,000 nm. (FIG. 7B) Example 3D plot of β-NaYF₄ nanowire electric field. Color bar shows the amplitude of the normalized electric field. (FIG. 7C) Plot of the calculated maximum source term values for a β-NaYF₄ nanowire with the laser incident on the bottom facet as a function of the wire length ranging from 100 nm to 2,000 nm. The edge length of the nanowire is kept constant at 255 nm.

FIG. 8: Powder X-ray diffraction pattern for the as-prepared (a) β-NaYF₄:10% Yb³⁺/0.1% Er³⁺, (b) β-NaYF₄:10% Yb³⁺, (c) β-NaYF₄, and (d) the standard data for hexagonal and cubic NaYF₄ (JCPDS No. 16-0334, JCPDS No. 06-0342) as a reference.

FIG. 9: Lifetime measurement setup.

FIGS. 10A-10C: Synthesis and characterization of cubic, α-NaYF₄ nanocrystals. (FIG. 10A) Schematic of cubic crystal structure of α-NaYF4 with Fm-3m space group symmetry. (FIG. 10B) Bright field transmission electron microscope (TEM) image of α-NaYF₄:10% Yb grains; scale bar=18 nm. Top inset: high-resolution TEM image taken from the indicated region; scale bar=15 nm. Bottom inset: select area electron diffraction from the indicated region. (FIG. 10C) X-ray fluorescence compositional-analysis-spectrum of an individual α-NaYF₄:10% Yb nanocrystal taken within the TEM confirming the elemental crystalline composition including Y, Yb, and F species.

FIGS. 11A and 11B: Laser refrigeration of cubic α-NaYF4 nanocrystals. (FIG. 11A) Crystal field energy level configuration of Yb³⁺ dopant ions in α-NaYF₄ cubic structure and β-NaYF4 hexagonal structure. Inset: optical micrograph of optically trapped α-NaYF₄ nanocrystal with Oₕ cation point group symmetry and β-NaYF₄ NW with C₃ₕ cation point-group symmetry. α-NaYF₄ scale bar=300 nm, β-NaYF₄ scale bar=1 μm (FIG. 11B) Temperature change of individually trapped cubic α-NaYF₄ nanocrystals with different Yb³⁺ dopant concentrations under increasing 1,020 nm laser irradiance. Error bars are based on standard deviation of ten samples.

FIG. 12: SEM for the as prepared β-NaYF₄:10% Yb³⁺. The length of nanowire is 1.39±0.17 μm and the diameter of the nanowire is 152±34 nm. The error bar is achieved from the standard deviation of 50 random nanowires.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a crystal is provided that includes yttrium-fluoride doped with a trivalent rare earth ion.

In another aspect, a method for cooling a solution is provided. In one embodiment, the method includes:

providing a solution comprising a crystal, as disclosed elsewhere herein; and

illuminating the solution with photons sufficient to excite an electron in the crystal, thereby emitting a blue-shifted photon and cooling the solution.

In another aspect, a system is provided that includes:

a solution comprising a crystal as disclosed elsewhere herein; and

a light source configured to illuminate the solution sufficient to excite an electron in the crystal, thereby emitting a blue-shifted photon and cooling the solution.

In another aspect, a method for hydrothermal synthesis of a crystal comprising yttrium-fluoride doped with at least one trivalent rare earth ion is provided. In one embodiment, the method includes:

providing a first solution, comprising a yttrium-containing compound and trivalent rare earth ion dopant precursor selected from the group consisting of a ytterbium-containing compound, an erbium-containing compound, and a combination thereof;

providing a second solution, comprising a fluoride compound selected from the group consisting of lithium fluoride and sodium fluoride; and

mixing and hydrothermally reacting the first solution and the second solution to provide a crystal comprising yttrium-fluoride doped with at least one trivalent rare earth ion.

In another aspects, a theranostic agent is provided. In one embodiment, the theranostic agent includes:

a yttrium-fluoride crystal doped with a trivalent rare-earth ion, as disclosed elsewhere herein, wherein the crystal is conjugated to a target-binding moiety capable of selectively binding to a target.

In yet another aspect, a method of performing therapeutic hypothermia on a subject is provided. In one embodiment, the method includes:

administering a therapeutic amount of a yttrium-fluoride crystal doped with a trivalent rare-earth ion, as disclosed elsewhere herein; and

locally applying light to a portion of the subject in need of therapeutic hypothermia, thereby exciting an electron in the trivalent rare earth doped yttrium-fluoride crystal, which emits a blue-shifted photon, and cooling the portion of the patient.

### DETAILED DESCRIPTION

The present disclosure relates crystals capable of cooling upon illumination (e.g., “laser refrigeration”). In certain embodiments, the crystals include yttrium-fluoride doped with a trivalent rare earth ion. Exemplary crystals include yttrium-lithium-fluoride crystals and yttrium-sodium-fluoride crystals, doped with Yb³⁺, Er³⁺, or a combination of both. Methods of producing the crystals hydrothermally and methods of cooling a solution are also provided. Further methods include use of the crystals for therapeutic hypothermia. Finally, a theranostic is provided that includes the crystals conjugated to a targeting moiety capable of selectively binding to a target.

In one aspect, a crystal is provided that includes yttrium-fluoride doped with a trivalent rare earth ion. The crystal is capable of cooling upon illumination due to a vibration-free, anti-Stokes photoluminescence process, which is described in greater detail in the Examples below. The yttrium-fluoride provides a lattice in which the trivalent rare earth ion is doped. The rare earth ions are excited upon illumination and produce the cooling effect. In one embodiment, the trivalent rare earth ion is selected from the group consisting of Yb³⁺, Er³⁺, and a combination thereof.

The crystals include trivalent rare-earth ions. The trivalent rare-earth ions can be any trivalent rare-earth. In certain embodiments, the trivalent rare-earth ions are Yb³⁺ ions and/or Er³⁺ ions. In one embodiment, the rare earth ion is present in the crystal in the range of 0.5% to 15%, by weight. In a further embodiment, only a single species of rare earth ion is present in the crystal and that single species is present in the range of 0.5% to 15%, by weight.

In another embodiment, two or more species of rare earth ions (e.g. Yb³⁺ and Er³⁺) are present in the crystal, with a total combined amount of 0.5% to 15%, by weight. As an example, in one embodiment Yb³⁺ is present in the range of 0.4% to 10% and Er³⁺ is present in the range of 0.1% to 5%.

Cooling using the crystal can be diminished or eliminated when the rare earth ion doping reaches a critical level, which is at or near 15%, by weight. Accordingly, in one embodiment, the rare earth ion (single-species or two or more species) is present in the crystal in the range of 0.5% to 10%, by weight.

In one embodiment, the trivalent rare-earth ion is Yb³⁺, thus providing a Yb³⁺ doped yttrium-fluoride crystal.

In one embodiment, the trivalent rare-earth ion is Er³⁺, thus providing an Er³⁺ doped yttrium-fluoride crystal. In a further embodiment, the crystal comprises Er³⁺ in the range of 1% to 5%, by weight.

In certain embodiments, the crystal is selected from the group consisting of a yttrium-lithium-fluoride (YLF) crystal and a yttrium-sodium-fluoride crystal (NaYF₄). YLF is disclosed in detail in Example 1 and NaYF₄ is disclosed in Example 2. Laser refrigeration is demonstrated in both Examples using the trivalent rare earth ion dopants Yb³⁺, Er³⁺, and a combination of the two.

Turning now to YLF, in particular, in one embodiment, the crystal is YLF and includes the rare earth ion present in the crystal in the range of 0.5% to 15%, by weight. In a further embodiment, only a single species of rare earth ion is present in the crystal and that single species is present in the range of 0.5% to 15%, by weight.

In an alternative embodiment, two or more species of rare earth ions (e.g. Yb³⁺ and Er³⁺) are present in the crystal, with a total combined amount of 0.5% to 15%, by weight. As an example, in one embodiment Yb³⁺ is present in the range of 0.4% to 10% and Er³⁺ is present in the range of 0.1% to 5%.

Turning now to NaYF₄, in particular, in one embodiment, the crystal is NaYF₄ and includes the rare earth ion present in the crystal in the range of 0.5% to 15%, by weight. In a further embodiment, only a single species of rare earth ion is present in the crystal and that single species is present in the range of 0.5% to 15%, by weight.

In an alternative embodiment, two or more species of rare earth ions (e.g. Yb³⁺ and Er³⁺) are present in the crystal, with a total combined amount of 0.5% to 15%, by weight. As an example, in one embodiment Yb³⁺ is present in the range of 0.4% to 10% and Er³⁺ is present in the range of 0.1% to 5%.

In one embodiment, the crystal is polycrystalline.

In certain embodiment, the crystal is formed using a hydrothermal synthesis. Materials similar to the disclosed crystals have been prepared by the Czochralski (Cz) method, but to the inventors' knowledge crystals such as those disclosed herein have not been crown by the Cz (or any other) method. By preparing the disclosed crystals using a hydrothermal synthetic method (described in further detail below), relatively large single-crystals can be grown—of the size that allows for laser refrigeration. The disclosed crystals demonstrate different diffraction patterns compared to those grown by Cz method, indicating physical differences in the crystal lattice and composition.

In one embodiment, the crystal is a nanowire. In one embodiment, a nanowire has an aspect ratio (length:width) of greater than 1. In one embodiment, a nanowire has an aspect ratio (length:width) of greater than 10. In one embodiment, a nanowire has an aspect ratio (length:width) of greater than 100. In one embodiment the crystal is a YLF nanowire doped with Yb³⁺, Er³⁺, or both. In another embodiment the crystal is a NaYF₄ nanowire doped with Yb³⁺, Er³⁺, or both.

In one embodiment, the smallest dimension of the crystal is in the range of 100 nm to 1.5 μm. In one embodiment, the smallest dimension of the crystal is in the range of 100 nm to 1.0 μm. In one embodiment, the smallest dimension of the crystal is in the range of 100 nm to 500 nm. In one embodiment, the crystal is a nanowire and the smallest dimension is a width of the nanowire.

Methods of Cooling Using the Crystals

In another aspect, a method for cooling a solution is provided. In one embodiment, the method includes:

providing a solution comprising a crystal, as disclosed elsewhere herein; and

illuminating the solution with photons sufficient to excite an electron in the crystal, thereby emitting a blue-shifted photon and cooling the solution. While laser refrigeration of materials similar (although not identical to) to those disclosed herein has been demonstrated in vacuum, it is the inventors' belief that cooling in solution has never before been demonstrated. The exceptional cooling abilities of the disclosed crystals enable cooling in solution. There are several practical implications of laser refrigeration in solution as opposed to in vacuum, including the potential for cooling inside a subject (e.g., in vivo), including methods of hypothermia, as will be discussed in greater detail below.

The methods of the present disclosure comprise illuminating the solution and, thereby, exciting an electron in the crystal, which emits a blue-shifted photon, and cooling the solution. The light source can be any light source capable of exciting an electron within the crystal, which then emits a blue-shifted photon. Such lights sources can include laser light sources. The wavelength or wavelengths emitted by the light source will depend upon the particular crystal or crystals used in a particular method.

In one embodiment, the crystal is selected from the group consisting of a yttrium-lithium-fluoride crystal and a yttrium-sodium-fluoride crystal.

In one embodiment, the crystal is a Yb³⁺ doped yttrium-lithium-fluoride crystal and wherein the illumination is energetically sufficient to pump (excite) the E4-E5 resonance of the Yb³⁺ doped yttrium-lithium-fluoride crystal. As discussed below in Example 1, the long (ms) excited-state lifetimes of Yb³⁺ excited states (e.g., E5) allow them to absorb optical-phonons from the host crystal lattice, followed by spontaneous anti-Stokes fluorescence (with a higher mean photon energy compared to the absorbed photons) that ultimately removes heat from the lattice and cools both the crystal and its immediate surroundings.

In one embodiment, illuminating the solution with photons sufficient to excite an electron in the crystal comprises illuminating with photons having wavelengths of 1020 nm or less. In one embodiment, illuminating the solution with photons sufficient to excite an electron in the crystal comprises illuminating with photons having wavelengths in the range of 400 nm to 1020 nm. In one embodiment, illuminating the solution with photons sufficient to excite an electron in the crystal comprises illuminating with photons having wavelengths in the (near-IR) range of 700 nm to 1020 nm.

In one embodiment, illuminating the solution comprises illuminating the solution with laser light.

The light source providing the illuminating photons can be any light source known to those of skill in the art that can be configured to impinge on the solution and crystal, such that the electron in the crystal can be excited sufficiently to emit a blue-shifted photon and cool the solution.

Exemplary light sources include lasers.

In one embodiment, the trivalent rare-earth ion is Yb³⁺, thus providing a Yb³⁺ doped yttrium-fluoride crystal.

In one embodiment, the Yb³⁺ doped yttrium-fluoride crystal comprises Yb³⁺ in the range of 0.5% to 15%, by weight.

In one embodiment, the smallest dimension of the crystal is in the range of 100 nm to 1.5 μm.

In one embodiment, the crystal is polycrystalline.

In one embodiment, the crystal is a nanowire. In one embodiment the crystal is a YLF nanowire doped with Yb³⁺, Er³⁺, or both. In another embodiment the crystal is a NaYF₄ nanowire doped with Yb³⁺, Er³⁺, or both.

In one embodiment, the crystal further comprises Er³⁺ ions.

In one embodiment, the crystal comprises Er³⁺ in the range of 1% to 5%, by weight.

In one embodiment, the crystal is a yttrium-sodium-fluoride crystal with a hexagonal crystal lattice or a cubic crystal lattice.

In one embodiment, the solution is an aqueous solution. In one embodiment, the solution is deuterated water.

In one embodiment, the solution is a biological sample. As used herein, the term “biological sample” refers to a sample obtained from a living being. The biological sample may be of any biological tissue, cells, fluid, or combinations thereof. Such biological samples include, but are not limited to, sputum, blood, serum, plasma, blood cells (e.g., white cells), tissue, cell-containing body fluids, free floating nucleic acids, urine, and saliva,

In one embodiment, the solution is inside a subject. In one embodiment the subject is a mammal. In one embodiment, the subject is a cell. In one embodiment, the subject is a human.

In one embodiment, a portion of the solution adjacent to the crystal is cooled by about 5° C. to about 25° C. As used herein, the term “about” indicates that the subject number can be modified by plus or minus 5% and still fall within the disclosed embodiment. As used herein, the term “adjacent” refers to a volume of solution surrounding the crystal, or a volume of solution that surrounds a plurality of crystals. “Adjacent” include both direct contact between crystal and solution, as well as indirect thermal contact between crystal and solution (e.g., through an intermediate material).

Crystal Cooling System

In another aspect, a system is provided that includes:

a solution comprising a crystal as disclosed elsewhere herein; and

a light source configured to illuminate the solution sufficient to excite an electron in the crystal, thereby emitting a blue-shifted photon and cooling the solution.

Crystals and solutions encompassed by the system include those disclosed elsewhere herein. For example, representative crystals include any and all disclosed yttrium-fluoride doped crystals with at least one trivalent rare earth ion. Representative solutions include water and biological solutions.

The light source can be any light source known to those of skill in the art that can be configured to impinge on the solution and crystal, such that the electron in the crystal can be excited sufficiently to emit a blue-shifted photon and cool the solution.

Exemplary light sources include lasers.

Hydrothermal Synthesis of Crystals

In another aspect, a method for hydrothermal synthesis of a crystal comprising yttrium-fluoride doped with at least one trivalent rare earth ion is provided. In one embodiment, the method includes:

providing a first solution, comprising a yttrium-containing compound and trivalent rare earth ion dopant precursor selected from the group consisting of a ytterbium-containing compound, an erbium-containing compound, and a combination thereof;

providing a second solution, comprising a fluoride compound selected from the group consisting of lithium fluoride and sodium fluoride; and

mixing and hydrothermally reacting the first solution and the second solution to provide a crystal comprising yttrium-fluoride doped with at least one trivalent rare earth ion.

The hydrothermal synthesis produces crystals according to the embodiments disclosed herein. In particular, crystals that include yttrium-fluoride doped with at least one trivalent rare earth ion. Representative crystals include a yttrium-lithium-fluoride (YLF) crystal and a yttrium-sodium-fluoride crystal (NaYF₄). In certain embodiments, the crystals are doped with Yb⁺³, Er⁺³, or a combination thereof. The doping amounts are disclosed elsewhere herein.

The hydrothermal synthesis combines two or more solutions along with heat in order to form the crystals.

As disclosed in Example 1, in one embodiment, the first solution includes yttrium nitrate (Y(NO3)3), ytterbium nitrate (Yb(NO3)3) and erbium nitrate (Er(NO3)3) dissolved in water. The second solution includes LiF and of NH4HF2 in water. Solutions one and two are mixed together and heated to 220° C. for 72 h to complete the hydrothermal reaction to provide Yb³⁺:LiYF4 particles (e.g., nanowires).

Another representative method is disclosed in Example 2, wherein Yttrium nitrate (Y(NO₃)₃), ytterbium nitrate (Yb(NO₃)₃) and erbium nitrate (Er(NO₃)₃) are dissolved in deionized water with sodium hydroxide (NaOH). In a second solution, sodium fluoride (NaF) is mixed with water and ethanol. The two solutions are mixed for 5 hours of hydrothermal treatment at 200° C. β-NaYF₄:10% Yb³⁺ nanowires are obtained after the hydrothermal treatment.

It will be appreciate that the compounds, amounts, and reaction conditions of the disclosed embodiments can be altered as required to produce the desired crystals, according to the embodiments disclosed herein.

Theranostic Agent

In another aspects, a theranostic agent is provided. In one embodiment, the theranostic agent includes:

a yttrium-fluoride crystal doped with a trivalent rare-earth ion, as disclosed elsewhere herein, wherein the crystal is conjugated to a target-binding moiety capable of selectively binding to a target.

The yttrium-fluoride crystals doped with trivalent rare-earth ions are substantially similar to those described in other aspects of the present disclosure. Such theranostic particles comprise a target-binding moiety capable of selectively binding to a target. Target binding moieties include a peptide, a protein, a polysaccharide, an oligosaccharide, a glycoprotein, a lipid, a lipoprotein, a nucleic acid, an aptamer, and an antibody, or antigen-binding fragment thereof.

Targets include an antibody, an antigen, a cell, a nucleic acid, an enzyme, a substrate for an enzyme, a protein, a lipid, a carbohydrate, or other biomarker. In certain embodiments, the target is indicative of or related to an indication or illness, such as cancer.

As used herein, “selectively binds” or “specifically binds” refers to the ability of a target-binding moiety to bind to its target with a KD 10⁻⁵ M (10000 nM) or less, e.g., 10⁻⁶ M, 10⁻⁷ M, 10⁻⁸ M, 10⁻⁹ M, 10⁻¹⁰ M, 10⁻¹¹ M, 10⁻¹² M, or less. Selective binding can be influenced by, for example, the affinity and avidity of the target binding moiety and the concentration of the target. The person of ordinary skill in the art can determine appropriate conditions under which the target binding moiety described herein selectively bind the targets using any suitable methods, such as titration of a polypeptide agent in a suitable cell binding assay, or as described in the examples that follow.

In one embodiment, the target is selected from the group consisting of an antibody, an antigen, a cell, a nucleic acid, an enzyme, a substrate for an enzyme, a protein, a lipid, a carbohydrate, or other biomarker.

In one embodiment, the target-binding moiety is selected from the group consisting of a peptide, a protein, a polysaccharide, an oligosaccharide, a glycoprotein, a lipid, a lipoprotein, a nucleic acid, an aptamer, and an antibody, or antigen-binding fragment thereof.

In one embodiment, the yttrium-fluoride crystal is selected from the group consisting of a yttrium-lithium-fluoride crystal and a yttrium-sodium-fluoride crystal.

In one embodiment, the yttrium-fluoride crystal is a Yb³⁺ doped yttrium-fluoride crystal.

In one embodiment, the Yb³⁺ doped yttrium-fluoride crystal comprises between 5%-15% Yb³⁺ by weight.

In one embodiment, the yttrium-fluoride crystal further comprises Er³⁺ ions.

In one embodiment, the yttrium-fluoride crystal comprises between 1%-5% Er³⁺ by weight.

In one embodiment, the yttrium-fluoride crystal is polycrystalline.

In one embodiment, the crystal is a nanowire. In one embodiment the crystal is a YLF nanowire doped with Yb³⁺, Er³⁺, or both. In another embodiment the crystal is a NaYF₄ nanowire doped with Yb³⁺, Er³⁺, or both.

In one embodiment, the smallest dimension of the yttrium-fluoride crystal is between 100 nm and 1.5 μm.

Therapeutic Hypothermia Methods

In yet another aspect, a method of performing therapeutic hypothermia on a subject is provided. In one embodiment, the method includes:

administering a therapeutic amount of a yttrium-fluoride crystal doped with a trivalent rare-earth ion, as disclosed elsewhere herein; and

locally applying light to a portion of the subject in need of therapeutic hypothermia, thereby exciting an electron in the trivalent rare earth doped yttrium-fluoride crystal, which emits a blue-shifted photon, and cooling the portion of the patient.

The crystals useful in such methods of performing therapeutic hypothermia are substantially similar to those described elsewhere in the present disclosure. In certain embodiments, the particles contain a target-binding moiety, as described elsewhere herein, useful in targeting or directing the crystal to a portion of the subject. In certain other embodiments, the crystals to not contain a target-binding moiety and the light is merely applied locally, thereby cooling only that portion of the subject.

As used herein, the phrase “therapeutically effective amount,” “effective amount” or “effective dose” refers to an amount that provides a therapeutic benefit in the treatment, prevention, or management of any disease or indication that is dependent upon hypothermia. Indications that are hypothermia-dependent include forms of certain forms of cancer.

Determination of a therapeutically effective amount is well within the capability of those skilled in the art. Generally, a therapeutically effective amount can vary with the subject's history, age, condition, sex, as well as the severity and type of the medical condition in the subject, and administration of other pharmaceutically active agents.

As used herein, the term “treat,” “treatment,” or “treating,” means to reverse, alleviate, ameliorate, inhibit, slow down or stop the progression or severity of a symptom or condition of the disorder being treated. The term “treating” includes reducing or alleviating at least one adverse effect or symptom of a condition. Treatment is generally “effective” if one or more symptoms are reduced. Alternatively, treatment is “effective” if the progression of a condition is reduced or halted. That is, “treatment” may include not just the improvement of symptoms, but also a cessation or slowing of progress or worsening of symptoms that would be expected in the absence of treatment. Beneficial or desired clinical results include, but are not limited to, alleviation of one or more symptom(s), diminishment of extent of the deficit, stabilized (i.e., not worsening) state of a tumor or malignancy, delay or slowing of tumor growth and/or metastasis, and an increased lifespan as compared to that expected in the absence of treatment.

As used herein, the term “administering,” refers to the placement of a therapeutic into a subject by a method or route deemed appropriate. The therapeutic can be administered by any appropriate route, which results in an effective treatment in the subject including orally, parentally, by inhalation spray, rectally, or topically in dosage unit formulations containing conventional pharmaceutically acceptable carriers, adjuvants, and vehicles. The term parenteral as used herein includes, subcutaneous, intravenous, intra-arterial, intramuscular, intrasternal, intratendinous, intraspinal, intracranial, intrathoracic, infusion techniques or intraperitoneally. Dosage regimens can be adjusted to provide the optimum desired response (e.g., a therapeutic response). A suitable dosage range may, for instance, be 0.1 μg/kg-100 mg/kg body weight; alternatively, it may be 0.5 μg/kg to 50 mg/kg; 1 μg/kg to 25 mg/kg, or 5 μg/kg to 10 mg/kg body weight. The theranostic agents can be delivered in a single bolus, or may be administered more than once (e.g., 2, 3, 4, 5, or more times) as determined by an attending physician.

As used herein, “locally applying light” refers to illuminating a portion of the subject. Such portions are typically portions of the subject susceptible to hypothermic treatment.

In one embodiment, the portion of the subject is a cancer cell.

In one embodiment, the crystal is conjugated to a targeting moiety.

In one embodiment, the targeting moiety selectively binds to a cancer cell.

The following examples are illustrative of disclosed methods and compositions. In light of this disclosure, those of skill in the art will recognize that variations of these examples and other examples of the disclosed methods and compositions would be possible without undue experimentation.

### Examples

### Example 1: Laser Refrigeration of Rare-Earth-Doped Lithium Yttrium Fluoride Nanowires

Advances in cryogenic sciences have enabled several observations of new low-temperature physical phenomena including superconductivity, superfluidity, and Bose-Einstein condensates. Heat transfer is critical in numerous fields of science and technology including thermal management within integrated microelectronics, photonic and microfluidic circuits, and the regulation of metabolic processes. In 1929, Pringsheim proposed that solid-state materials could experience refrigeration if they exhibited biased emission of anti-Stokes (blue-shifted) radiation relative to a fixed optical excitation wavelength. Epstein and colleagues experimentally demonstrated this concept first in 1995 using rare-earth-doped fluoride glass materials (ZBLAN). Optical refrigeration of a condensed phase with a rhodamine dye by anti-Stokes radiation has previously been reported but the results remain controversial. More recently, it has been shown that rare-earth-doped lithium yttrium fluoride (Yb³⁺:YLF) crystals grown in high-temperature Czochralski reactors can be cooled to cryogenic temperatures (˜90K) in vacuo using a continuous-wave NIR laser excitation. Furthermore, the laser refrigeration of doped yttrium aluminum garnet (Yb³⁺:YAG) materials has recently been reported in air at atmospheric pressure. Anti-Stokes photoluminescence has also been reported to cool cadmium sulfide (CdS) nanoribbons in vacuo by as much as 40° C. below room temperature. In contrast to anti-Stokes processes, optomechanical laser refrigeration has also been demonstrated based on a novel mechanism of angular momentum transfer between a circularly polarized laser and a birefringent crystal.

To date, laser-refrigeration of nanocrystals in aqueous media has not been reported stemming primarily from the large near-infrared (NIR) optical absorption coefficient of water (α_{H}2O|975ₙₘ˜0.5/cm). It has remained an open question whether these known cooling materials could act to refrigerate aqueous media and undergo hypothesized cold Brownian motion (CBM), or whether solvent heating from the background absorption coefficient of water would overwhelm the cooling of individual YLF crystals. Furthermore, it is not obvious a priori that YLF crystals made through hydrothermal processing would have sufficiently low background impurity levels to achieve laser cooling. In this work, we demonstrate the local laser refrigeration of hydrothermal YLF nanocrystals dispersed within several different aqueous media including deionized water, heavy water (D₂O), and physiological electrolytes. Refrigeration >10° C. below ambient conditions is observed in phosphate buffered saline (PBS) following anti-Stokes photoluminescence from optically trapped, rare-earth-doped YLF nanocrystals undergoing CBM.

Results & Discussion

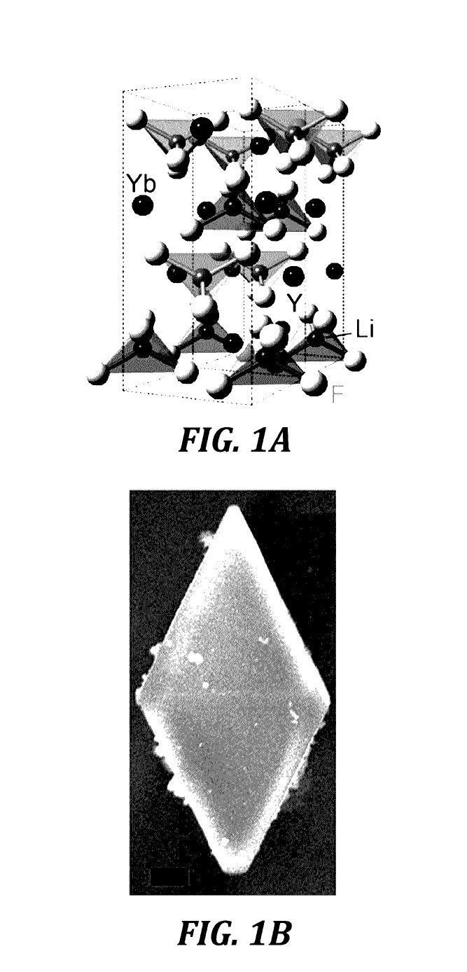

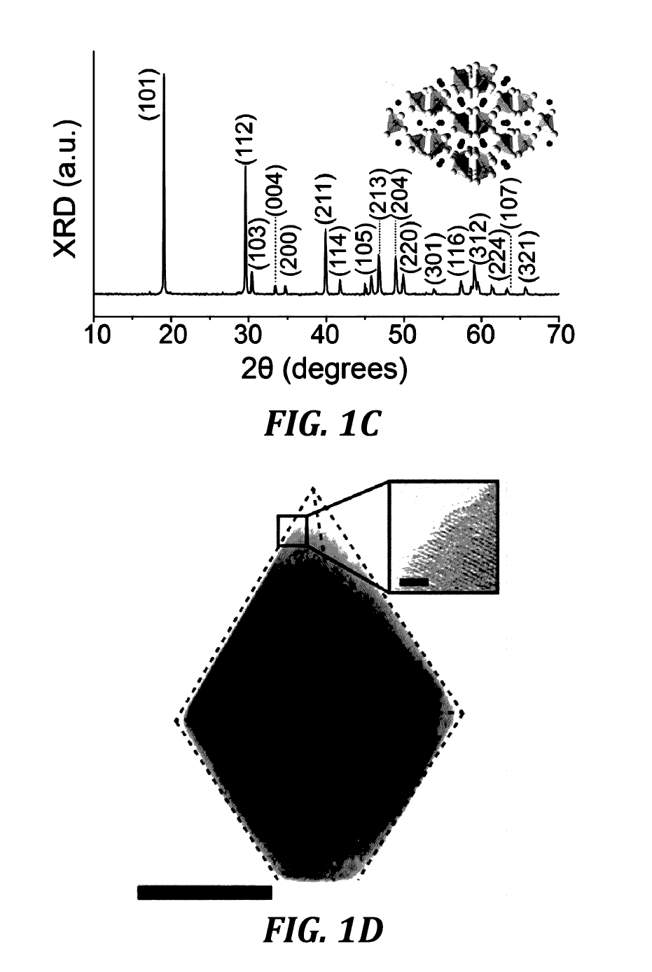

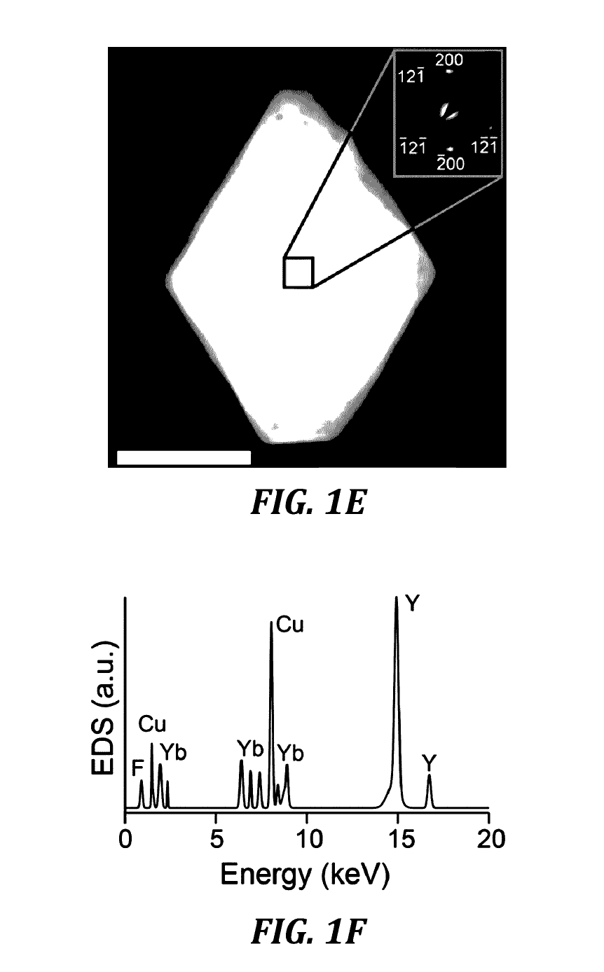

Pioneering efforts to cool Yb³⁺:YLF materials in vacuo have relied on the growth of high-purity YLF single-crystals using an air- and moisture-free Czochralski process. In the experiments reported here, a low-cost modified hydrothermal synthesis of Yb³⁺:YLF is used to prepare crystals shown in FIG. 1. Scanning electron microscopy reveals that YLF crystals exhibit a truncated tetragonal bipyramidal (TTB) morphology (FIG. 1B). X-ray diffraction shows that the YLF crystal has a Scheelite structure (FIG. 1C). Bright field/HAADF TEM imaging (FIG. 1D/E) and electron diffraction suggest that the TTB materials are polycrystalline and likely form through an oriented attachment process of nanocrystalline grains (FIG. 1E, inset).

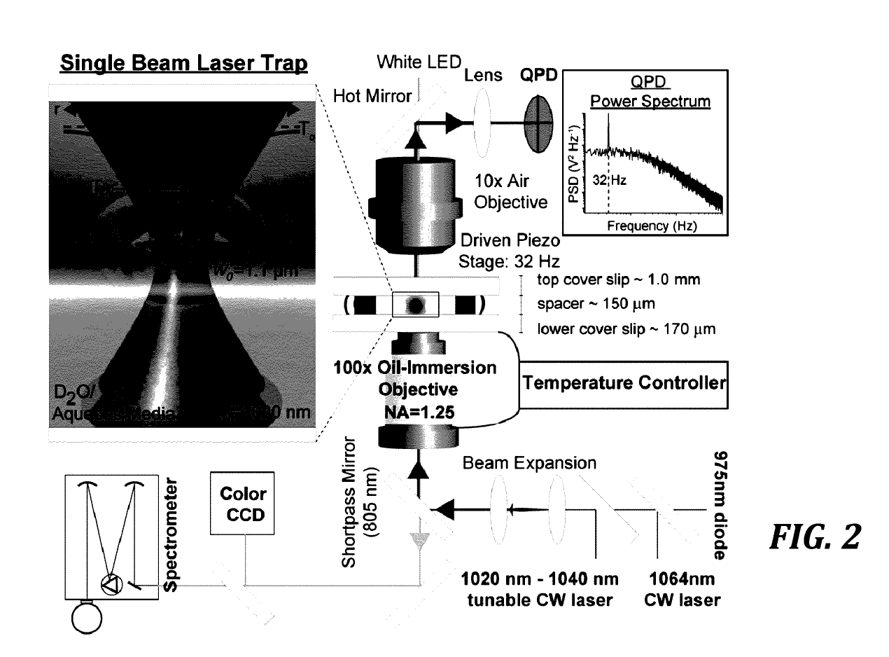

A home-built laser trapping instrument (shown in FIG. 2) was used to observe the Brownian dynamics of individual Yb³⁺:YLF nanocrystals. The laser trap setup is outlined in Materials & Methods, and the CBM temperature analysis is described elsewhere herein. Briefly, the single-beam laser trap was used to extract the surrounding local temperature profile of YLF particles through observations of forward-scattered laser radiation profiles that are processed to yield both the calibrated power spectral density and diffusion coefficient for individual YLF crystals. The laser refrigeration of 10% Yb³⁺:YLF nanocrystals by more than 10° C. in phosphate-buffered saline (PBS) and Dulbecco's Modified Eagle's Medium (DMEM) was observed at a trapping wavelength of λ=1020 nm (Table 1). In order to minimize fluid heating at control NIR trapping wavelengths (λ=975 nm & 1064 nm), experiments discussed below were performed in D₂O, unless explicitly stated otherwise, due to its low absorption compared to H₂O.

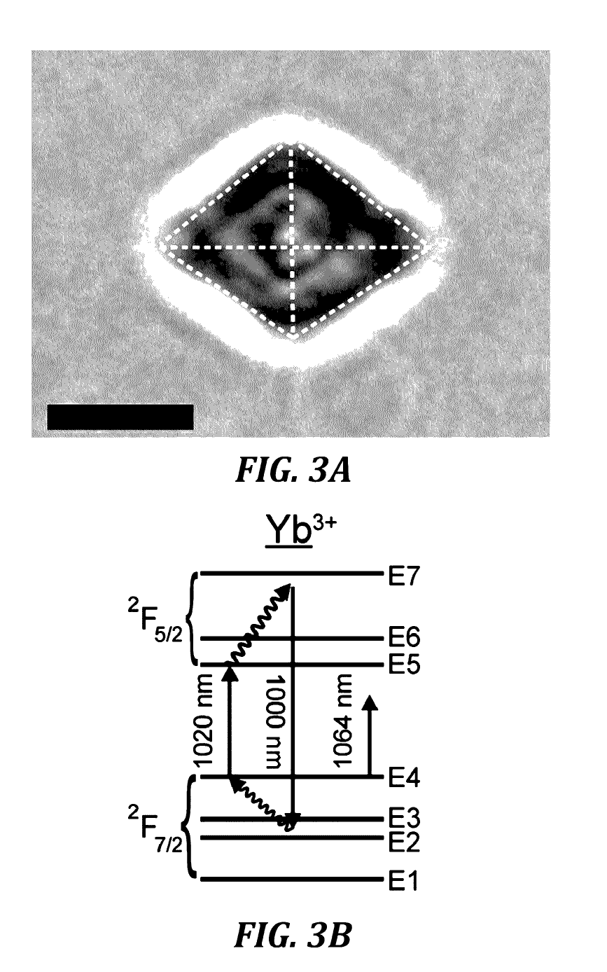

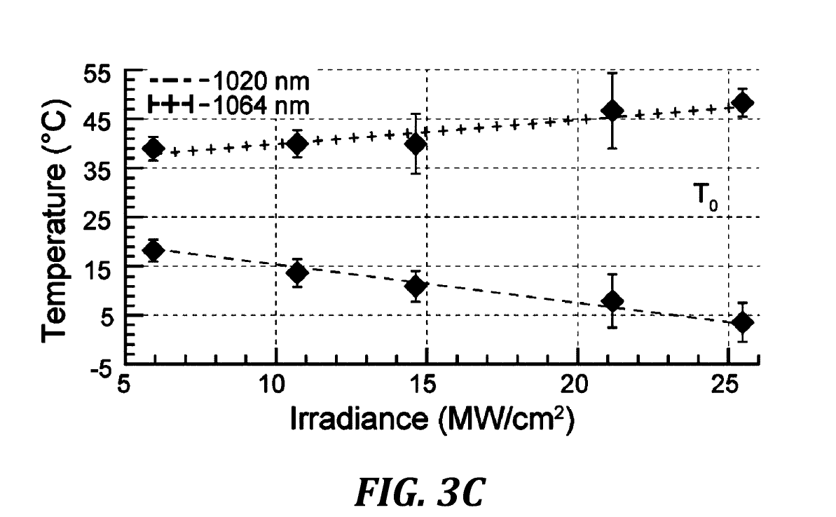

A bright-field micrograph for a characteristic optically-trapped Yb³⁺:YLF crystal is shown in FIG. 3A. The dependence of laser refrigeration on the trapping laser's pump wavelength is shown in FIG. 3C, where YLF crystals doped with 10% Yb³⁺ are observed to cool from 19° C. at a 5.9 MW/cm² trapping irradiance to 4° C. at a 25.5 MW/cm² trapping irradiance when trapped with λ=1020 nm, which is resonant with ytterbium's E4-E5 transition shown in FIG. 3B. The same Yb³⁺:YLF crystals are shown to heat from 40° C. to 47° C. when trapped at the same respective irradiances with λ=1064 nm, which is energetically insufficient to pump the E4-E5 resonance and subsequently cannot initiate upconversion-mediated cooling (FIG. 3B).

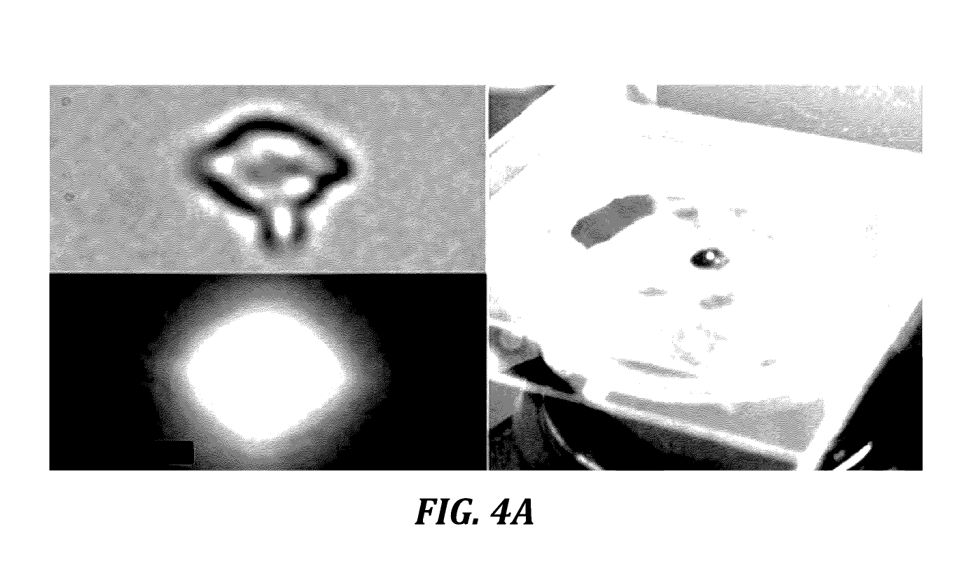

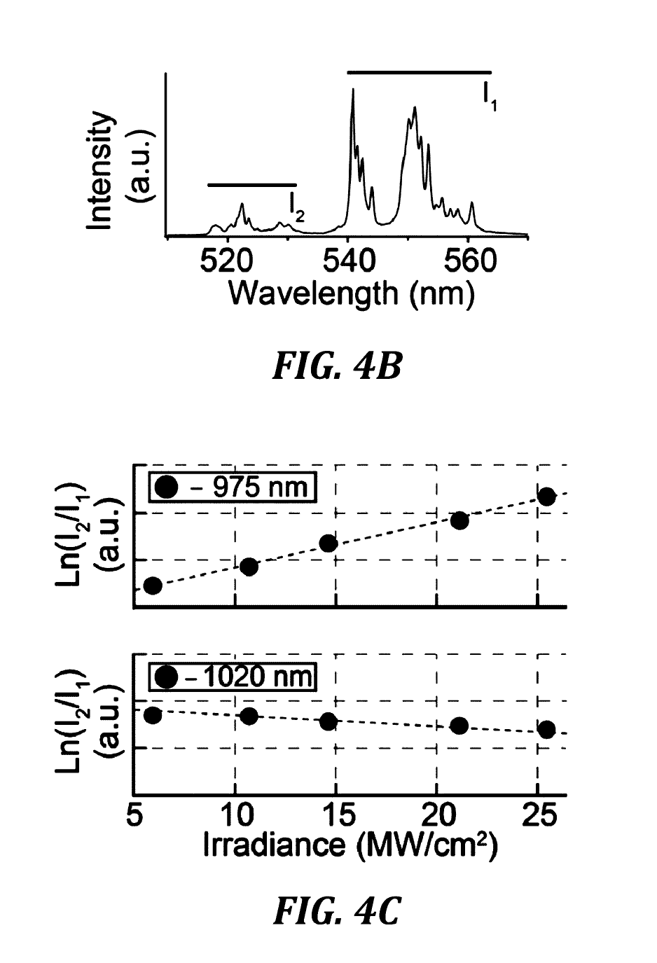

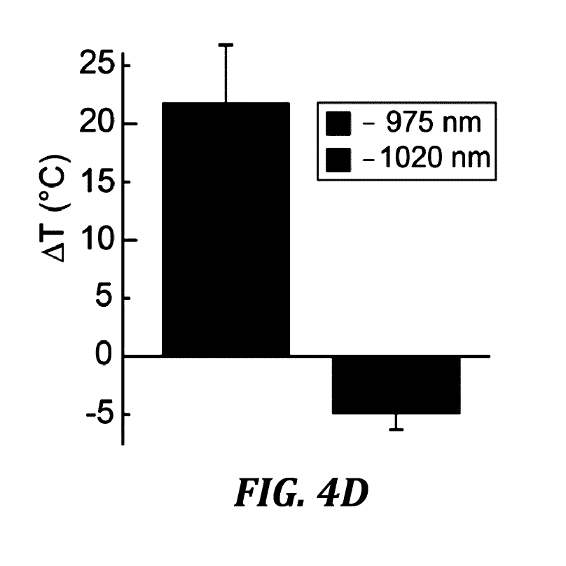

The CBM analysis discussed above is limited to reporting local solvent temperatures, but it does not provide information on the internal lattice temperature of optically-trapped YLF nanocrystals. It is well known that codoping YLF crystals with both Yb³⁺ and Er³⁺ ions leads to a thermalized Boltzmann distribution between the E₂ (²H_{11/2}) and E₁ (⁴S_{3/2}) manifolds of Er³⁺ and an intense green upconversion emission that is visible to the unaided eye (shown in FIG. 4A). This upconversion process is enabled by the long (ms) photoluminescence lifetimes from the rare-earth point defects. It has also been shown that this upconverted photoluminescence from Er³⁺ may also be used to infer temperature changes through ratiometric thermometry by analysis of the photoluminescence emission from different Boltzmann thermal populations given by the equation:

$$\frac{{I}_{2}}{{I}_{1}} ∝ exp [ \frac{- ( {E}_{2} - {E}_{1} )}{{k}_{b} T} ] \qquad [ 1 ]$$

In brief, changes in the ratio of the integrated emission bands I₂ and I₁ that stem from transitions between energy states E₂ and E₁, respectively, and a common ground state are directly correlated to a change in the particle's temperature. Furthermore, it has been recently reported that strong visible upconversion in rare-earth codoped nanocrystals can be used for efficient biological imaging and labeling.

Photoluminescence spectroscopy of optically-trapped YLF nanocrystals provides a unique capability of observing particle-to-particle variability within an ensemble. For the codoped 2% Er³⁺, 10% Yb³⁺:YLF particles reported, substantial fluctuations in upconversion photoluminescence was observed, indicating that ensemble calibrations are inapplicable to quantitative ratiometric temperature measurements of individual nanocrystals. However, ratiometric thermometry can still be used during laser trapping experiments to make qualitative observations of temperature changes as the trapping irradiance is increased, as shown in FIG. 4B/C. The decrease (increase) in the logarithmic ratio of I₂ to I₁ (FIG. 4B/C) with increasing irradiance reflects a decrease (increase) in the internal lattice temperature, which agrees well with the observed temperature changes measured via laser trapping light scattering temperature analysis (FIG. 4D). Specifically, laser trapping analysis of the particles' CBM indicates that codoped 2% Er³⁺, 10% Yb³⁺:YLF undergoes laser refrigeration (ΔT=−4.9±2.8° C.) when trapped at λ=1020 nm and heating (ΔT=21.8±10.11° C.) when trapped at λ=975 nm. Furthermore, it has been proposed recently that codoping YLF crystals with other upconverting rare-earth ions can enhance cooling through energy transfer enhanced cooling.

Outlook.

These results illustrate the potential of using singly- and co-doped YLF nanocrystals as a platform for precision circuit cooling, physiological refrigeration, biological imaging, and in situ ratiometric thermometry. Potential applications for these materials include precision temperature control in integrated electronic, photonic, and microfluidic circuits; as well as triggering and probing fundamental metabolic processes. In particular, the ability to measure and to modulate temperature could enable the investigation of the kinetics and temperature sensitivity of cellular processes, including ion channel actuation, conformational folding dynamics of RNA, and dynamic stepping motion of molecular myosin (V) motor proteins.

Analyzing the CBM of a nanocrystal dispersed in a liquid phase to measure the nanocrystal's temperature also provides the unique capability to predict the local temperature gradient in the medium surrounding the trapped nanocrystal. Since the aspect ratio of the truncated tetragonal bipyramid morphology encountered for YLF crystals is near unity, we approximate the radius R of the particles using an equivalent sphere model and can extract the local temperature field a distance r from the particles' surface (at temperature Tₚ, excluding the temperature discontinuity at the particle's surface from the Kapitza resistance), which is given by:

$$T ( r ) = {T}_{0} + \frac{R}{r} ( {T}_{p} - {T}_{0} ) \qquad [ 2 ]$$

where T₀ is the bath temperature of the medium. Given that the average radius of the Yb³⁺:YLF particles trapped at λ=1020 nm in FIG. 3C is R_{avg}=764±293 nm, T₀=25° C., and T_{p,avg}=3.4° C. at 25.5 MW/cm² irradiance, the distance away from the particle where the temperature increases to within 1% of T₀ is 6.9 μm (FIG. 2). However, this treatment assumes that the local temperature profile around the cold particle behaves according to Eq. 2. Yet, it is also conceivable that the region around the cold particle is surrounded by a hot corona that slowly diminishes to the base temperature of the solvent.

In the future it can be envisioned that the refrigeration of particle ensembles and local mapping of the surrounding solvent temperature profile can be achieved through the generation of multiple laser traps, via either holographic phase masks or galvo-steering mirrors, to bring a temperature-sensing particle into close proximity to a cooling YLF particle. Future synthetic efforts with YLF host crystals will be directed at controlling the grain size and morphology in pursuit of morphology dependent cavity resonances that can increase the optical absorption of Yb³⁺ and reduce the irradiance required to observe the laser refrigeration of physiological media. Furthermore, the low-cost hydrothermal approach reported here could be used to synthesize novel phases for host crystals (such as β-NaYF₄) that cannot be grown through single-crystal Czochralski methods.

Materials and Methods

YLF Synthesis.

Yttrium oxide (Y2O3), ytterbium oxide (Yb2O3) and erbium oxide (Er2O3) are of 99.99% purity and used as purchased from Sigma-Aldrich. Yttrium nitrate (Y(NO3)3), ytterbium nitrate (Yb(NO3)3) and erbium nitrate (Er(NO3)3) are obtained by dissolving the oxide in concentrated nitric acid at 60° C. while stirring for several hours until excess nitric acid is removed. The residual solid is then dissolved in Millipore deionized (DI) water to achieve a stock concentration of the respective nitrate. Lithium fluoride (LiF), nitric acid (HNO3), ammonium bifluoride (NH4HF2) and ethylenediaminetetraacetic acid (EDTA) are analytical grade and used directly in the synthesis without any purification. The following preparation uses the synthesis of 2% Er³⁺10% Yb³⁺:LiYF4 as an example. 7.04 ml of 0.5M Y(NO3)3, 0.8 ml of 0.5M Yb(NO3)3 and 0.16 ml of 0.5M Er(NO3)3 are mixed with 1.17 g EDTA in 5 ml Millipore DI water at 80° C. while stirring for 1 h. This is solution A. Subsequently, 0.21 g of LiF and 0.68 g of NH4HF2 are dissolved in 7 ml Millipore DI water at 70° C. while stirring for 1 h to form solution B. Solutions A and B are mixed together while stirring for 20 min to form a homogeneous white suspension which is then transferred to a 23 ml Teflon-lined autoclave and heated to 220° C. for 72 h. After the autoclave cools to room temperature, the 2% Er³⁺, 10% Yb³⁺:LiYF4 particles can be recovered by centrifuging and washing with ethanol and Millipore DI water three times. The final white powder is obtained by calcining at 300° C. for 2 h. 10% Yb³⁺:LiYF4 particles are achieved using the same method.

TEM Characterization.

Bright field and STEM HAADF images were taken on a FEI Tecnai G2 F20 at an accelerating voltage of 200 keV. Select area electron diffraction (SAED) images were taken with a camera length of 490 mm. EDS spectra were obtained with a 60 second acquisition time. The spectra were then processed by subtracting the background and smoothing the peaks.

SEM Characterization.

Secondary electron images were taken on an FEI Sirion at an accelerating voltage of 5 keV.

XRD Characterization.

Powder x-ray diffraction (XRD) patterns are obtained on a Bruker F8 Focus Powder XRD with Cu K (40 kV, 40 mA) irradiation (λ=0.154 nm). The 2θ angle of the XRD spectra is from 10° to 70° and the scanning rate is 0.01°s−1. The one minor unlabeled peak in the XRD spectra at 2θ=44.9° is attributed to a small amount of unreacted LiF precursor ((200) peak).

Laser Trapping Description.

The laser tweezer setup is a modified modular optical tweezer kit (Thorlabs, OTKB), where the original condenser lens has been replaced with a 10× Mitutoyo condenser (Plan Apo infinity-corrected long WD objective, Stock No. 46-144). The 100× objective focusing lens has a numerical aperture of 1.25 and a focal spot of 1.1 μm. The quadrant photodiode and piezostage were interfaced to the computer through a DAQ card (PCIe-6361 X Series, National Instruments) and controlled through modified MATLAB software (Thorlabs). Experimental chambers were prepared as follows. Several microliters of the nanocrystal/aqueous medium dispersion were transferred by a pipette into a chamber consisting of a glass slide and glass coverslip. The edges of the glass slide and the glass coverslip were then sealed with a 150-μm-thick adhesive spacer (SecureSeal Imaging Spacer, Grace Bio-labs). Nanocrystals were trapped at the center (˜75 μm from the surface) of the temperature controlled perfusion chamber (RC-31, Warner Instruments) and held at T₀=25° C. while voltage traces were recorded at the quadrant photodiode (QPD) for 3 seconds at a sample rate of 100 kHz. The QPD voltage signal was calibrated by oscillating the piezostage at 32 Hz and an amplitude of 150 nm peak-to-peak during signal acquisition, as outlined in reference. Trapping data was acquired using a diode-pumped solid state Yb:YAG thin-disk tunable laser (VersaDisk 1030-10, Sahajanand Laser Technologies) at a wavelength of 1020 nm, a 975 nm pigtailed Fiber Bragg Grating (FBG) stabilized single-mode laser diode (PL980P330J, Thorlabs), as well as a solid-state Nd:YAG 1064 nm (BL-106C, Spectra-Physics) at an irradiance of 5.9, 10.7, 14.6, 21.2, and 25.5 MW/cm². Each YLF cooling data point in FIG. 3C in the manuscript represents an average of 6 individual particles with an average radius of 764 nm with a standard deviation of 293 nm. Magnitudes of cold Brownian temperature changes presented were determined using methods outlined in reference. Silica beads (SS04N/9857, Bangs Laboratories) were used for their monodisperse size distribution (1010 nm diameter), and they have shown to minimally heat when trapped with a laser tweezer at NIR wavelengths. Electromagnetic simulations of the interaction of the trapping laser with a YLF TTB were also performed to predict the stable trapping configurations of optically trapped YLF particles. Lastly, visible emission of Er³⁺ from Er/Yb codoped trapped YLF host crystals was detected using an Acton SpectraPro 500i spectrograph with a Princeton liquid-nitrogen cooled Si detector.

Cold Brownian Motion Temperature. Power spectra from the QPD voltage traces were processed according to Berg-Sorensen and Flyvbjerg and used to calibrate the QPD traces following the method of Toli'c-Norrelykke et al. An experimental diffusion coefficient was then extracted by fitting the characteristic function for the experimental power spectra derived in Berg-Sorensen and Flyvbjerg. Given that the temperature of the trapped particle is significantly different than the temperature sufficiently far from the laser focus, the particle-trap system is not isothermal and behaves according to nonequilibrium dynamics. Thus, equating the experimental diffusion coefficient to nonisothermal Brownian dynamics necessitates the application of CBM, as derived by Chakraborty et al. The CBM diffusion coefficient is then related to the CBM temperature by:

$${D}_{CBM} = \frac{{k}_{b} {T}_{CBM}}{{γ}_{CBM} ( T )} , \qquad [ 3 ]$$

where D_{CBM} is the CBM diffusion coefficient, k_{b} is Boltzmann's constant, T_{CBM} is the CBM temperature, and γ_{CBM}(T) is the CBM Stokes drag. To the leading order of the temperature increment or decrement ΔT=(Tp−T0), the temperature-dependence of the viscosity on T_{CBM} can be neglected, giving the effective temperature

$${T}_{CBM} = {T}_{0} + \frac{5}{12} Δ T . \qquad [ 4 ]$$

To account for the solvent viscosity temperature dependence, we follow the methods of Reference and use the Vogel-Fulcher-Tammann-Hesse (VF) law with the viscosity functional form

$$η ( T ) = {η}_{∞} exp [ \frac{A}{( T - {T}_{VF} )} ] ,$$

the CBM stokes drag is given by

γ_{CBM}(T)=6πRη_{CBM}(T), [5]

where R is the particle radius, and η_{CBM}(T) is the temperature-dependent CBM viscosity that is related to the viscosity of the solvent at room temperature, η₀, by

$$\frac{{η}_{0}}{{η}_{CBM} ( T )} \approx 1 + \frac{193}{486} [ ln ( \frac{{η}_{0}}{{η}_{∞}} ) ] [ \frac{Δ T}{( {T}_{0} - {T}_{VF} )} ] - {[ \frac{56}{243} ln ( \frac{{η}_{0}}{{η}_{∞}} ) - \frac{12563}{118098} {ln}^{2} ( \frac{{η}_{0}}{{η}_{∞}} ) ] [ \frac{Δ T}{( {T}_{0} - {T}_{VF} )} ]}^{2} . \qquad [ 6 ]$$

Equations 4-6 are then used in Eq. 3 to obtain D_{CBM}, which is subsequently compared to the experimental diffusion coefficient to determine the particle temperature Tp (excluding the temperature discontinuity at the particle's surface from the Kapitza resistance). An alternative CBM temperature analysis using a semi-phenomenological expression for D_{CBM} that approximately accounts for higher order terms in ΔT (Eq. 15 of the supporting online materials of Chakraborty et al.) yields consistent results, indicating that these higher order corrections are negligible, for our purposes. For the experiments reported here, the VF viscosity parameters were fit to experimental data and are as follows:

D₂O η_{∞}=3.456*10⁻⁵ Pa·A=478.6K s T_{VF}=160K,

and

DI water, PBS, DMEM η∞=2.664*10⁻⁵ Pa·s A=536.5K T_{VF}=145.5K.

VFT viscosity parameters for DI water, PBS (0.01M, pH 7.4; Sigma P5368), and DMEM (1X, high glucose, pyruvate; Life Technologies Cat. #11995-065) were assumed to be equivalent since it has been reported that water viscosity can be used for purposes of modeling particle transport in non-serum containing media.

Certain embodiments of this disclosure are described herein, including the best mode known to the inventors for carrying out the disclosure. Of course, variations on these described embodiments will become apparent to those of ordinary skill in the art upon reading the foregoing description. The applicants expect skilled artisans to employ such variations as appropriate, and the applicants intend for the various embodiments of the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to printed publications throughout this specification. Each of the cited references and printed publications are individually incorporated herein by reference in their entirety.

It is to be understood that the embodiments of the present disclosure are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure.

It will be apparent to those having skill in the art that many changes may be made to the details of the above-described embodiments without departing from the underlying principles of the disclosure. The scope of the present invention should, therefore, be determined only by the following claims.

### Example 2. Laser Refrigeration of Ytterbium-Doped Sodium-Yttrium-Fluoride Nanowires

Sodium-yttrium-fluoride (NaYF₄) upconverting nanocrystals are currently being investigated for a range of applications including bio-imaging, color displays, solar cells, and photocatalysis. Recent laser-refrigeration-of-solids (LRS) results have achieved cryogenic temperatures through a vibration-free, anti-Stokes photoluminescence process. Although hexagonal (β) NaYF₄ has been predicted to be a candidate material for LRS, laser refrigeration has not been reported for NaYF₄ due to challenges with the growth of Czochralski single-crystals. Here, we report the laser-refrigeration of Yb³⁺-doped β-NaYF₄ nanowires (NWs) in aqueous media via single-beam near-infrared (NIR) optical trapping at an irradiance of ˜1 MW/cm². Heat is transferred out of the NW's crystal lattice through anti-Stokes photoluminescence of excited Yb³⁺ ions following the absorption of optical phonons. Refrigeration is quantified to be >9° C. in D₂O through the analysis of the NW's cold Brownian motion (CBM). Single-particle experiments also reveal reversible cation-exchange reactions at the NW/water interface.

Rare-earth (RE) ions doped within fluoride host materials can convert long-wavelength NIR light (λ ˜1 μm) into shorter wavelength, visible emission (UV<λ<VIS) through a multi-photon upconversion process. Among all RE-doped fluoride host nanocrystals, NaYF₄ is considered to be one of the best materials for biological applications due to its low-toxicity, biocompatibility, and non-invasive deep-tissue penetration. NaYF₄ nanocrystals exhibit two different phases, either cubic (α) or hexagonal (β). Hexagonal β-NaYF₄ nanocrystals have been demonstrated to be more efficient than α-NaYF₄ nanocrystals for multi-photon upconversion. Additionally, different sizes and morphologies of β-NaYF₄ nanocrystals can be achieved through a low-cost, reproducible hydrothermal approach. β-NaYF₄ nanocrystals also have potential applications in bio-labeling, drug delivery, and photodynamic therapy.

In 1929, Pringsheim suggested that solid-state materials could cool via anti-Stokes emission at a resonant optical excitation wavelength. In 1946, Landau showed that the cooling process was thermodynamically consistent. Despite long-standing interest in using anti-Stokes laser refrigeration to cool solid-state gain media, the laser refrigeration of solid materials was not demonstrated experimentally until 1995 when Epstein and colleagues cooled a Yb³⁺-doped fluorozirconate glass (ZBLAN:Yb³⁺) in vacuum. Recently, the laser-cooling of bulk yttrium lithium fluoride (YLiF₄, or YLF) crystals has been reported to achieve a minimum temperature of 91K. The Kaviany group predicted that RE-doped nanocrystalline powders could enhance laser-cooling by increasing off-resonance phonon-assisted absorption. Recently, the laser refrigeration of nanocrystalline particles was reported in both air and condensed phases including liquid water and physiological buffers. In the case of laser-cooling in water, nanocrystalline YLF:Yb³⁺ materials can act to locally refrigerate the liquid phase with a continuous-wave NIR laser excitation in a laser trapping instrument, showing local cooling of individual particles by 21° C. below ambient temperature. β-NaYF₄ has also been predicted to be a promising host for laser cooling; however, to date, the laser-refrigeration of β-NaYF₄ single-crystals has not been reported due to challenges in bulk Czochralski crystal growth. Here we demonstrate that a continuous-wave, single-beam NIR laser-trap can be used to cool β-NaYF₄:10% Yb³⁺ NWs in heavy water (D₂O) by 9° C. below ambient conditions through anti-Stokes emission from the active Yb³⁺ dopant ions within the host crystal's lattice.

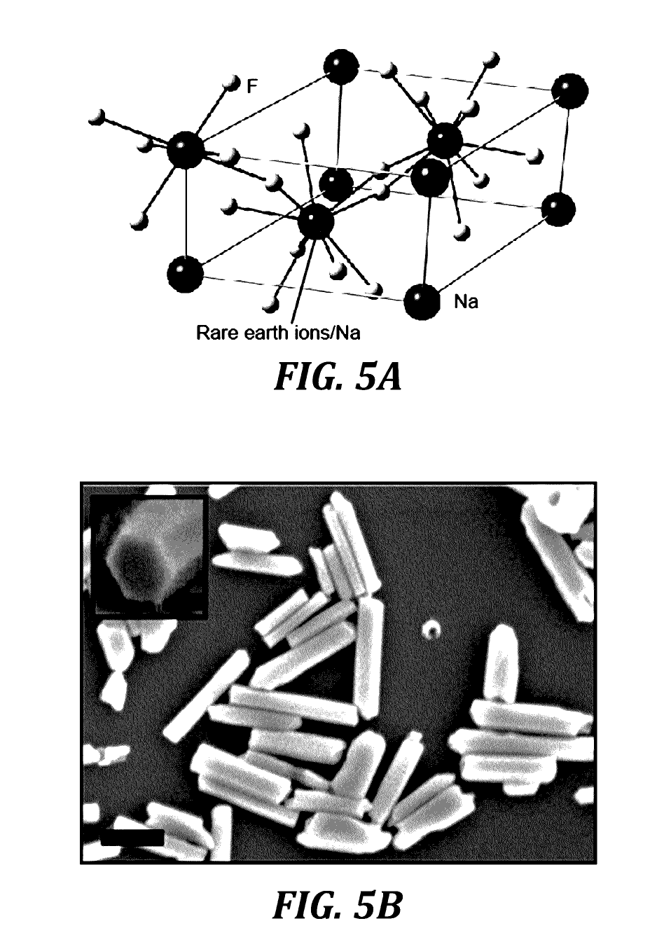

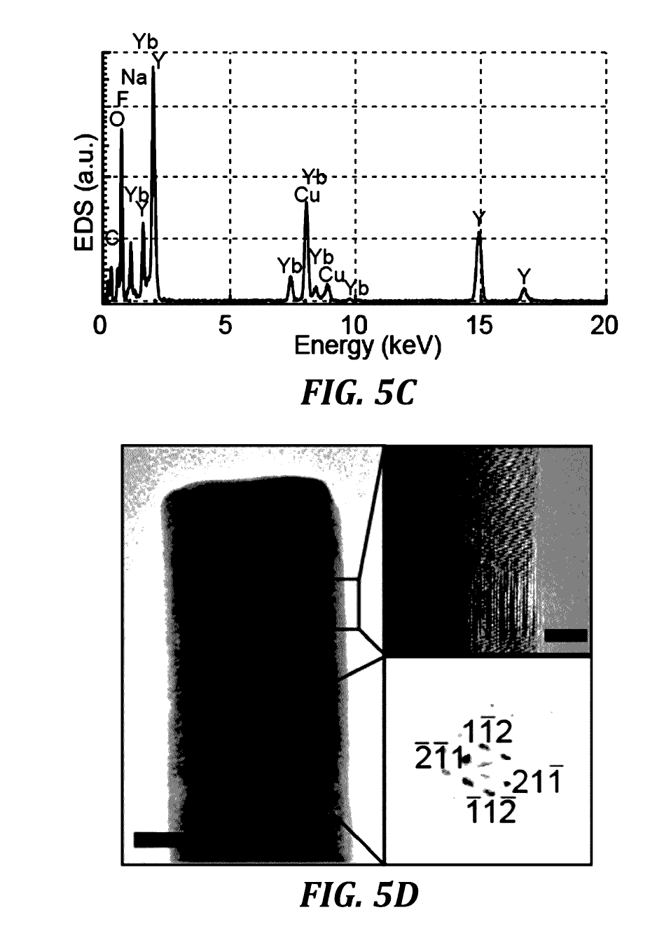

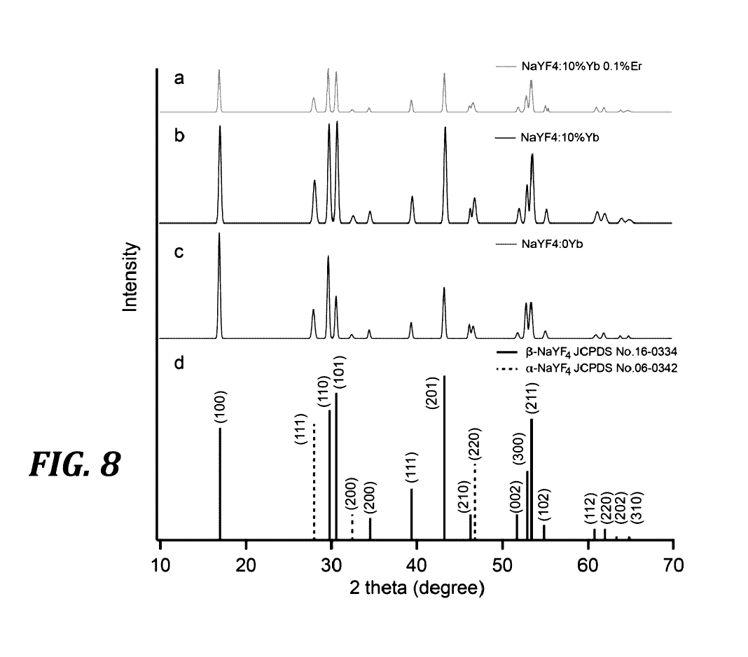

A low-cost, scalable hydrothermal synthesis approach is used to prepare β-NaYF₄ NWs that exhibit a hexagonal crystal structure shown in FIG. 5a. The crystal structure has been confirmed by powder X-ray diffraction pattern in FIG. 8. Scanning electron microscopy (SEM) (FIG. 5b) indicates that the NWs have a hexagonal cross-section. Energy dispersive x-ray spectroscopy (EDX) compositional analysis on an individual β-NaYF₄:10% Yb³⁺ NW (FIG. 5c) quantifies the elemental composition of the material containing Na, Y, F, and Yb. Bright-field, high-resolution transmission electron microscopy (TEM) imaging and select area electron diffraction (SAED) suggest that the β-NaYF₄:10% Yb³⁺ NWs are polycrystalline and the non-uniform contrast of the nanowire in FIG. 5d may be due to an oriented attachment growth mechanism of the nanowires, or electron beam damage generated from TEM imaging.

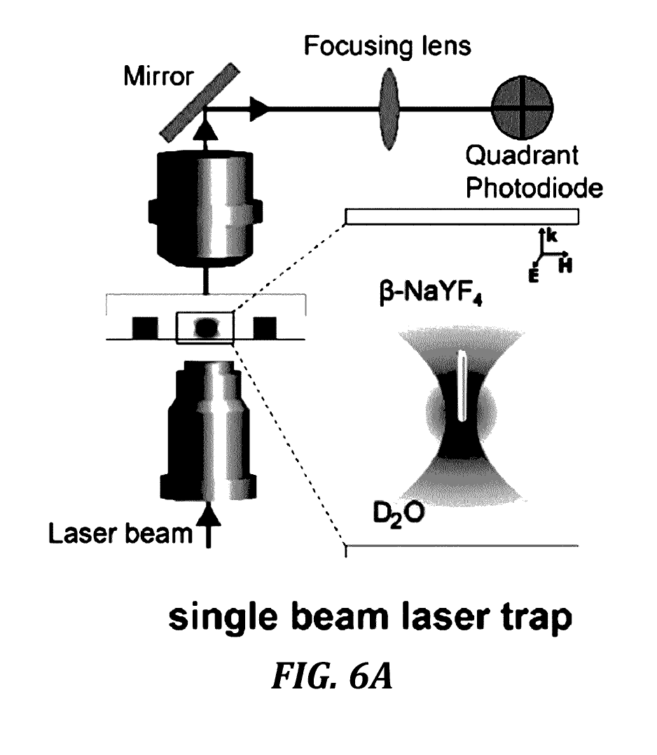

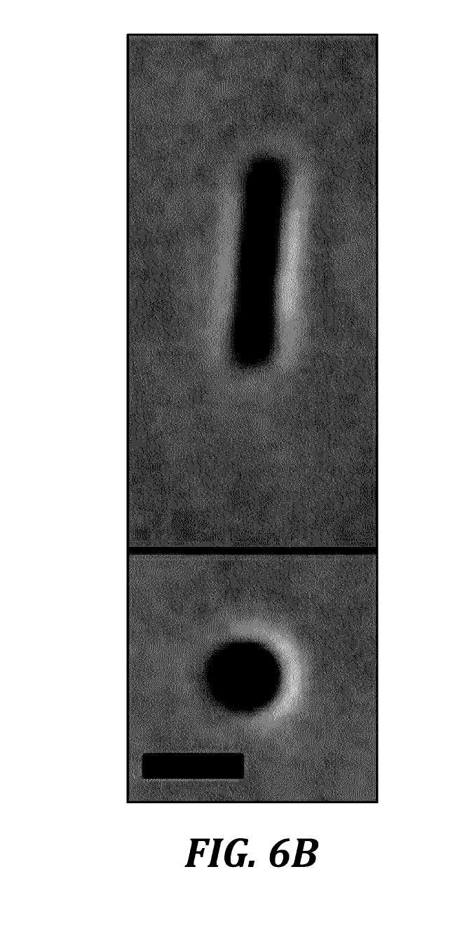

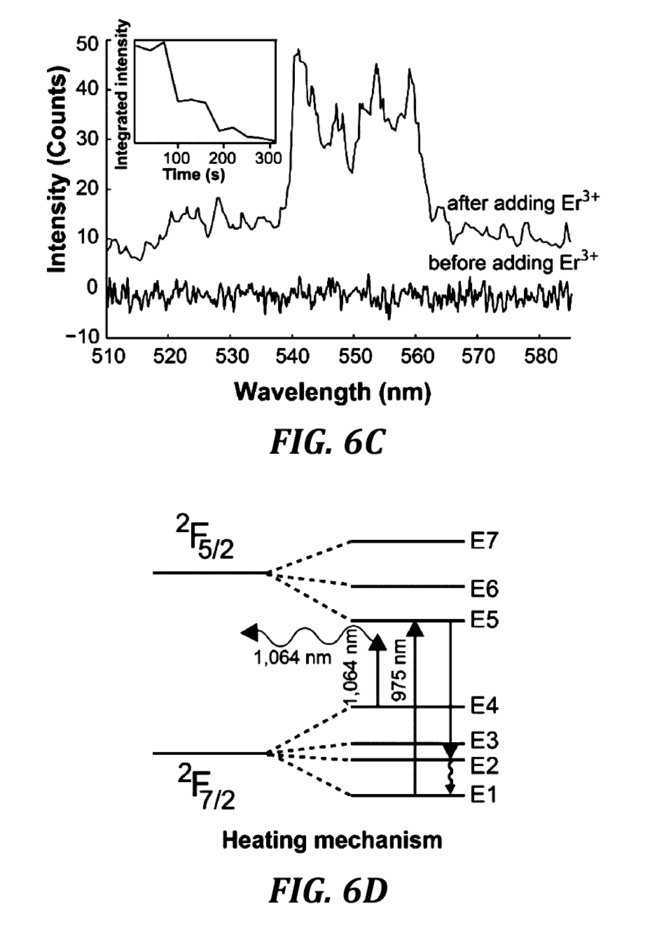

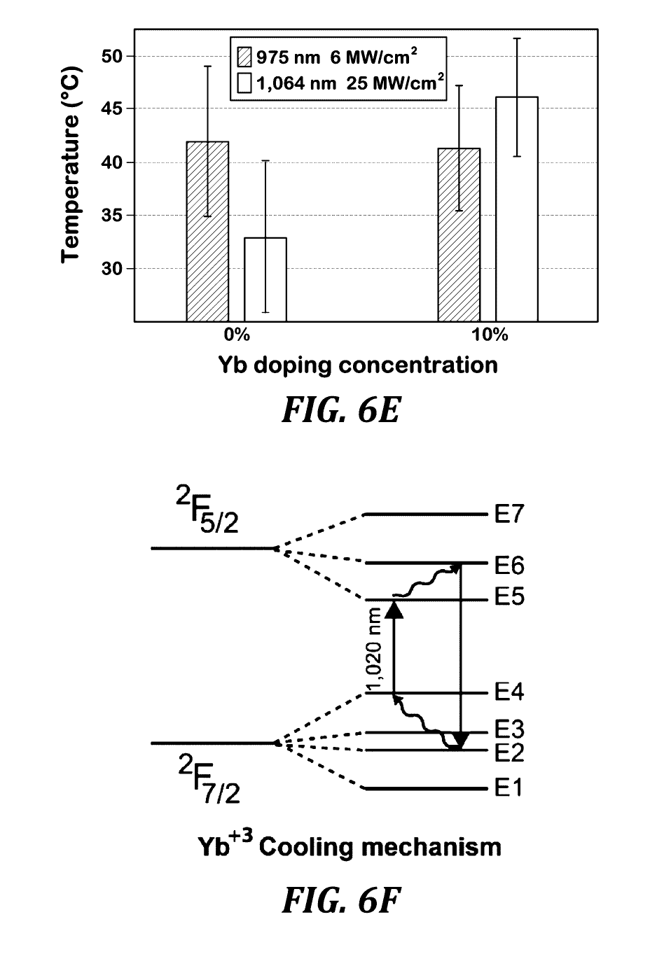

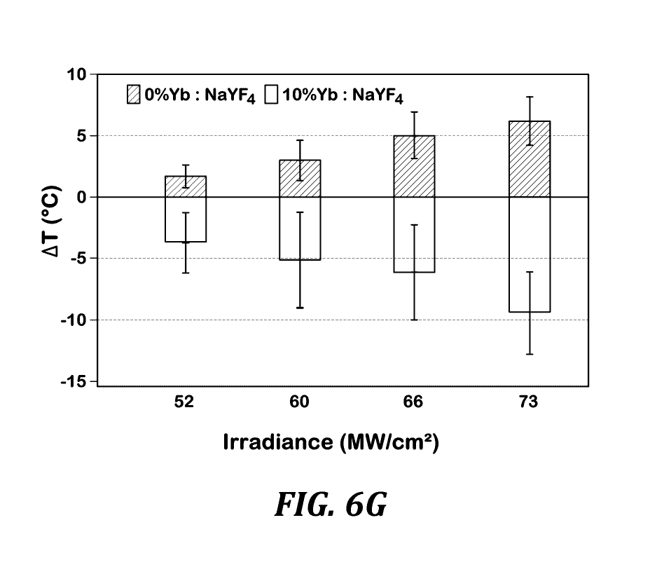

The local temperature of individual optically-trapped NWs in aqueous solution is extracted by analyzing their Brownian motion using a home-built, single-beam NIR laser trap system shown in FIG. 6a. A bright-field micrograph of a characteristic, optically-trapped β-NaYF₄ NW is shown in FIG. 6b. Forward-scattered laser radiation from optically-trapped NWs creates a dynamic interference pattern within the microscope's back-focal-plane that is detected with a high-speed silicon quadrant-photodiode (QPD). The time-dependent photovoltage signal from the QPD is then Fourier-transformed in order to compute the resulting power spectral density (PSD). A computer-controlled piezo-stage can be driven at a known frequency and amplitude to convert the units of the PSD from V²/Hz to m²/Hz in order to probe the local temperature of the aqueous solution surrounding the trapped NW in absolute temperature units (K). Unless stated otherwise, laser-trapping experiments were performed in D₂O in order to minimize optical absorption of the surrounding fluid medium.

Two NIR laser sources (λ=975 nm and 1,064 nm) were integrated within the laser trapping instrument in order to determine how the optical trap's NIR wavelength influences the temperature of β-NaYF₄ NWs. The dependence of heating on the Yb³⁺-dopant concentration and pumping wavelength is shown in FIG. 6e, where β-NaYF₄ NWs are irradiated by two different pumping lasers (975 nm & 1,064 nm). The average temperature of ten NWs is observed to rise from 33° C. to 46° C. when the Yb³⁺ dopant-concentration changes from 0% to 10%, respectively, using an optical trap with a fixed laser wavelength of λ=975 nm and a constant irradiance of 6 MW/cm². Laser heating is observed to depend on the concentration of Yb³⁺ dopants, with an increase in local heating with elevated Yb³⁺ doping concentration. When λ=975 nm the photon energy (1.27 eV) is sufficient to excite electrons from the E1 crystal-field state to E5 state followed by both radiative and non-radiative relaxation, leading to an increase in local solvent heating with increasing Yb³⁺ concentration. The same β-NaYF₄ NWs (with 0% and 10% Yb³⁺ doping) were used for control Brownian-thermometry experiments using a wavelength of λ=1,064 nm. In these controls, the temperature for both 0% and 10% doping was observed to remain at a temperature of 42° C. at an irradiance of 25 MW/cm². In contrast to experiments with λ=975 nm, when λ=1064 nm the photon energy (1.16 eV) is insufficient to pump the E4 to E5 resonance and heating is not observed to depend on the concentration of Yb³⁺ dopant ions.

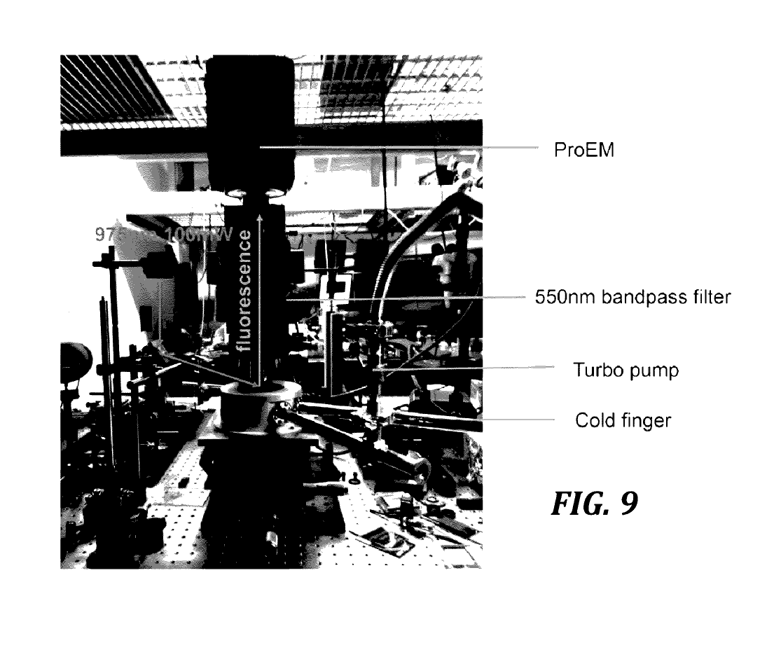

Single-particle laser-trapping experiments are also able to provide information on local mass-transport processes occurring at the solid/electrolyte interface. Recently, cation-exchange reactions have been shown to occur reversibly in ionic nanostructures at room temperature, which can be used to create complex shapes and compositions of nanocrystals. In addition, the Er³⁺ fluorescence can be used as a sensitive probe of surface states where excited ions may relax non-radiatively and cause heating. In FIG. 6c, the photoluminescence of Er³⁺-ions is tracked to monitor ion-exchange between the surface of β-NaYF₄ NWs and the surrounding electrolyte solution. First, β-NaYF₄:10% Yb³⁺ NWs were suspended in Er³⁺-nitrate solution for 24 hours to let Er³⁺ ions exchange and diffuse into the surface of individual NWs. The particles were then washed to remove excess Er³⁺ ions and resuspended in D₂O. The loss of Er³⁺ cations through diffusion at the solid-liquid interface was observed by measuring the gradual decay of visible photoluminescence from a single β-NaYF₄:10% Yb³⁺ NW irradiated with a 975 nm laser (FIG. 6c, inset). In comparison, β-NaYF₄:10% Yb³⁺ NWs showed no photoluminescence when trapped at the same conditions described above (FIG. 6c). Photoluminescence lifetime measurements of β-NaYF₄:10% Yb³⁺/1% Er³⁺ NWs in vacuum were made using the experimental configuration shown in FIG. 9. The lifetime of the Er^{3+ 4}S_{3/2} state is measured to be 221±6 μs at 300 K using a laser wavelength of 975 nm and an irradiance of 5.3 W/cm² which matches recently reported literature values.

The same instrument was used to conduct laser cooling experiments with β-NaYF₄:10% Yb³⁺ NWs. These NWs were observed to refrigerate by 9° C. below ambient temperatures when trapped at a wavelength of 1,020 nm, resonant with Yb³⁺ ions, at an irradiance of 73-MW/cm². The low-entropy laser excites electrons within Yb³⁺ ions from their E4 crystal-field level to their E5 level. The long (ms) excited-state lifetimes of Yb³⁺ excited states allow them to absorb optical-phonons from the host crystal lattice, followed by spontaneous anti-Stokes fluorescence (with a higher mean photon energy compared to the absorbed photons) that ultimately removes heat from the lattice and cools both the crystal and its immediate surroundings. As a control, β-NaYF₄:0% Yb³⁺ NWs trapped under identical conditions (73 MW/cm² with λ=1,020 nm) show heating by 6° C. above the ambient temperature (FIG. 6g). Without the Yb³⁺ ions, defects and impurities (including hydroxyl ions, capping ligands, etc.) can participate as non-radiative channels during multi-phonon relaxation processes that ultimately act to increase the surrounding fluid's temperature. Large laser irradiances are required to enable the optical trapping and photothermal characterization of single nanowires. The laser irradiance used here is above the saturation irradiance (127 kW/cm²) recently reported for Yb³⁺ ions in bulk yttrium-lithium-fluoride single crystals, and may reduce the migration of energy through Yb³⁺ ions to non-radiative nanocrystal surface-states.

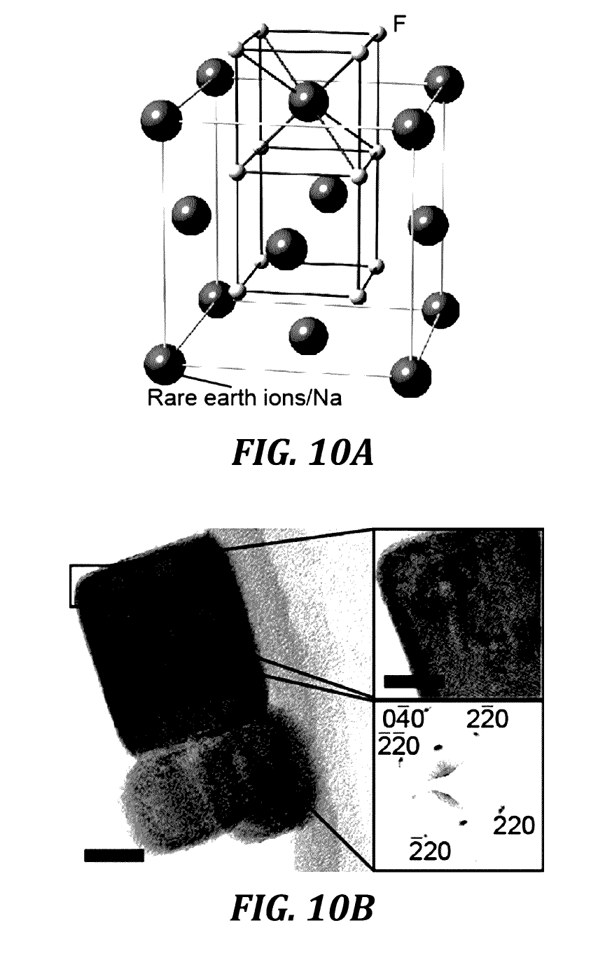

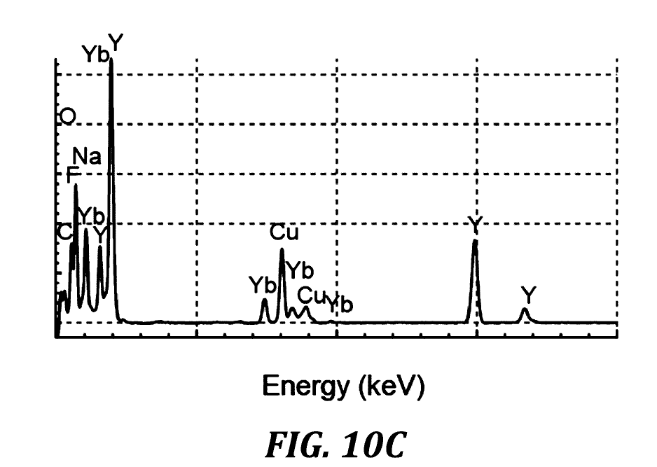

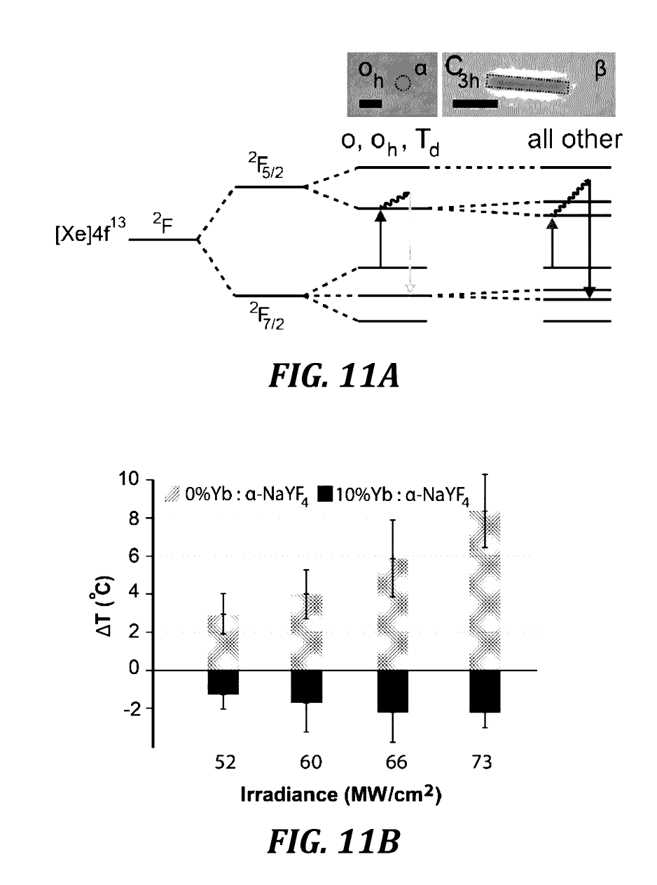

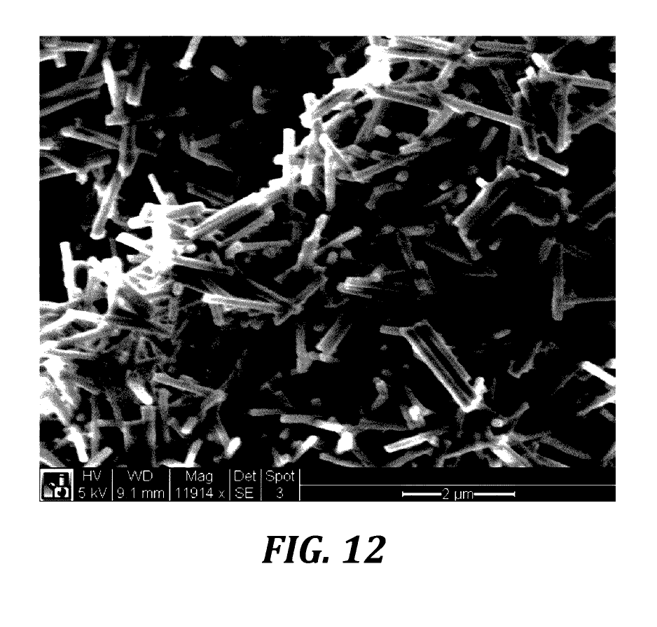

Similar experiments have been conducted on cubic α-NaYF₄ nanocrystals, where FIG. 10A shows their representative crystal structure and FIG. 10B shows morphology observed through TEM. FIG. 10C is an x-ray fluorescence compositional-analysis-spectrum of an individual α-NaYF₄:10% Yb nanocrystal taken within the TEM confirming the elemental crystalline composition including Y, Yb, and F species. Relative to hexagonal β-NaYF₄ nanowires, the cubic α-NaYF₄:10% Yb³⁺ nanocrystal is observed to cool by 2° C. below ambient conditions (FIG. 11B) at an identical laser trapping irradiance. This may be due to a larger crystal field splitting in the high-symmetry cubic α-NaYF₄:10% Yb³⁺ crystal structure relative to the smaller crystal field splitting in the low symmetry hexagonal β-NaYF₄:10% Yb³⁺ structure, which is shown in FIG. 11A. For the initial state of the pumped transition, a smaller crystal field splitting can provide a higher thermal population, which gives a higher pump absorption coefficient and, consequently, higher laser cooling power. Additionally, the higher surface to volume ratio of α-NaYF₄ compared to β-NaYF₄ will introduce more surface states, which may cause more nonradiative heat dissipation. Compared to bulk materials, the fluorescence reabsorption in nanocrystals is negligible. The laser heating and cooling effect can be tuned by changing the pumping laser wavelength (FIGS. 6e & g), with potential applications in single molecule biophysics.

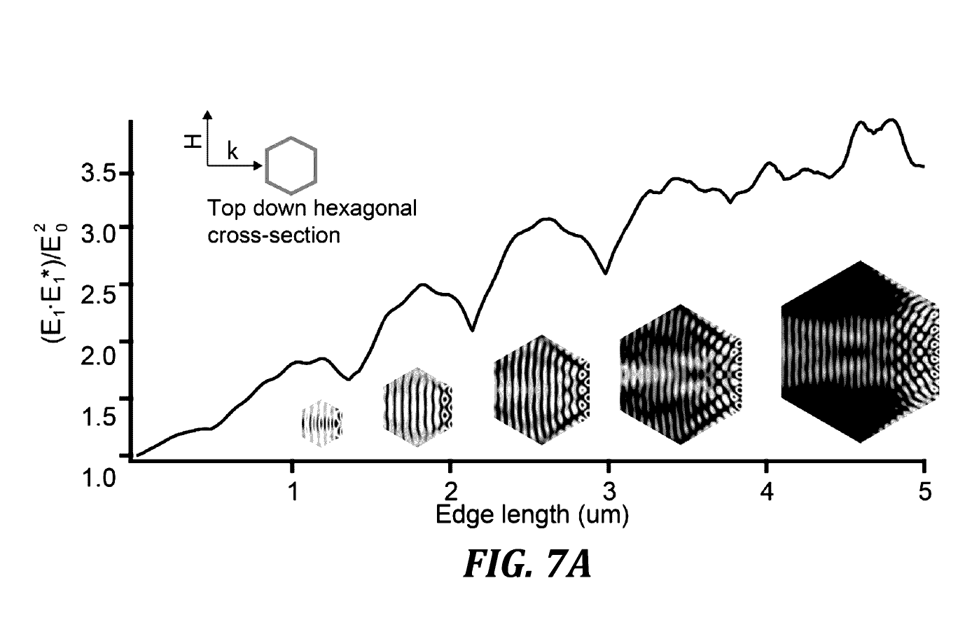

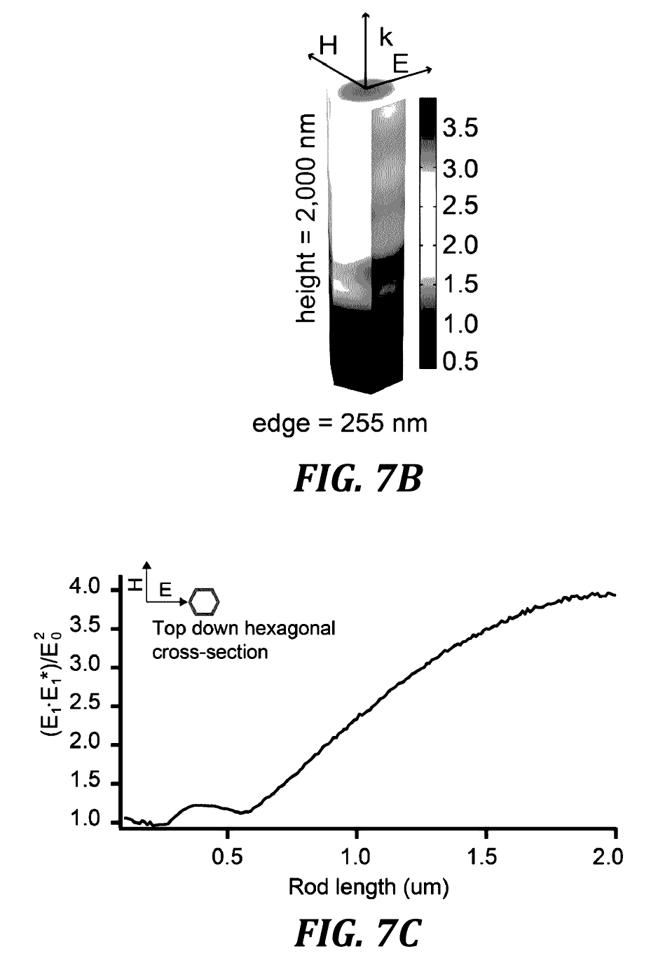

The size of individual nanocrystals has also recently been shown to affect the overall efficiency of their photoluminescence when pumped at a fixed laser wavelength. Modeling the internal optical field distribution within β-NaYF₄ NWs is important for understanding how a NW's size affects the absorption of incident electromagnetic radiation. Although numerous studies of light scattering and electromagnetic energy absorption of cylindrical nanostructures have been reported, there have been fewer studies of hexagonal wires. In FIG. 7 we plot results from finite element simulations of the internal optical fields within hexagonal β-NaYF₄ NWs using normalized units ((E₁·E₁*)/E₀²), where ‘E₁’ is the internal field, ‘E₁*’ is its complex conjugate, and ‘E₀’ is the electric field amplitude of the incident plane-wave. Morphology dependent resonances (MDRs) are observed to exist within β-NaYF₄ NWs for an incident wavelength with λ=1,020 nm. The localization of resonant modes within the NW can enhance the absorption of laser radiation. This field enhancement may compensate for the drawback of small optical interaction lengths in nanocrystalline materials, assuming the external radiative quantum efficiency of anti-Stokes cooling photons is not reduced. In the future, hydrothermal synthesis can be used to synthesize β-NaYF₄ NWs with different sizes and shapes in order to achieve a higher cooling efficiency by matching the pumping laser wavelength to an internal cavity resonance within the NW. Therefore, the cooling efficiency can be adjusted by changing not only the crystalline host matrix for rare-earth ions but also the nanostructure's size and morphology.

In conclusion, we have demonstrated for the first time that individual β-NaYF₄:10% Yb³⁺ NWs can be optically-trapped and refrigerated by a NIR, continuous-wave laser source in a fluid medium. Cation-exchange reactions are observed to occur in β-NaYF₄ NWs through an Er³⁺-exchange process at the solid/liquid interface. These results show the potential of using β-NaYF₄:10% Yb³⁺ NWs for applications in localized optoelectronic device cooling and physiological laser refrigeration. Further synthetic developments with β-NaYF₄:10% Yb³⁺ NW could enhance the resonant optical absorption of Yb³⁺ through the design of MDRs, or by reducing absorption from background impurity ions.

Experimental Sections

Hydrothermal Synthesis of β-NaYF₄:10% Yb³⁺/1% Er³⁺ NWs.

The following synthesis was performed after minor modifications to Ref. Yttrium oxide (Y₂O₃), ytterbium oxide (Yb₂O₃) and erbium oxide (Er₂O₃) are of 99.99% and purchased from Sigma-Aldrich. Yttrium nitrate (Y(NO₃)₃), ytterbium nitrate (Yb(NO₃)₃) and erbium nitrate (Er(NO₃)₃) are obtained by dissolving the rare earth oxide in nitric acid under 60° C. with stirring for several hours until the excess nitric acid is removed. The product is then dissolved in deionized water to achieve 1 mol/L of rare earth nitrate. Sodium hydroxide (NaOH), sodium fluoride (NaF), and oleic acid are analytical grade and used directly in the synthesis without any further purification. 18.6 MΩ Milli-Q deionized (DI) water is used for each synthesis. Two initially separate solutions were prepared. In solution A, an amount of 0.89 ml of 1 mol/L Y(NO₃)₃, 0.1 ml of 1 mol/L Yb(NO₃)₃ and 0.01 ml of 1 mol/L Er(NO₃)₃ were mixed with 2 ml 18.6 MΩ DI water and 8 ml ethanol. Then 3 ml oleic acid and 0.23 g NaOH were mixed into the solution with stirring. Solution B consisted of 168 mg NaF mixed with 3 ml 18.6 MΩ DI water and 3 ml ethanol. After each solution was stirred separately for 30 minutes, solution B was mixed into solution A drop-by-drop under vigorous stirring. After 30 minutes aging, the mixture was transferred into a 25 ml Teflon-lined autoclave for 5 hours of hydrothermal treatment at 200° C. After the autoclave cooled to room temperature, particles were isolated by washing and centrifuging with water and ethanol three times. The final white powder was obtained by drying the product at 60° C. for 12 hours. β-NaYF₄:10% Yb³⁺ NWs are also achieved by a similar method.

NaYF4 Characterization

Powder x-ray diffraction (XRD) patterns were obtained by Bruker F8 Focus Powder XRD with Cu Kα (40 kV, 40 mA) irradiation (λ=0.154 nm). The 2θ angle of the XRD spectra is from 10° to 70° and the scanning rate is 0.01° s⁻¹.

Scanning electron microscopy (SEM) images were taken on a FEI Sirion XL30 at an accelerating voltage of 5 keV.

Transmission electron microscopy (TEM) bright field images were taken on a FEI Tecnai G2 F20 at an accelerating voltage of 200 keV. Select area electron diffraction (SAED) images were taken with a camera length of 490 mm. EDS spectra were obtained with a 60 second acquisition time. The spectra were then processed by subtracting the background and smoothing the peaks.

Lifetime Measurement:

Lifetime measurement setup shown in FIG. 9. Lifetime measurements were taken with an electron-multiplying charge-coupled device (Princeton ProEM 512B) in spectra-kinetics mode with a frame rate of 5*10⁴/s. β-NaYF₄:10% Yb³⁺/1% Er³⁺ nanowires were excited with a Thorlabs 975 nm fiber-coupled laser diode at an irradiance of 5.3 W/cm² passed through a beam chopper at a rate of 200 Hz. Fluorescence light was collected through Thorlabs 550 nm bandpass filter. The temperature of the sample was controlled using a Janis ST-500 microscopy cryostat. The cryostat was pumped with Edwards T-station 75D to a pressure of 5*10⁻⁸ mbar.

Cooling Efficiency Comparison of β-NaYF₄ and CdS Nanobelt

Laser cooling of Yb³⁺ doped nanocrystals at cryogenic temperatures with reasonable efficiencies is only possible with materials which have small crystal-field splitting of the ground-state multiplet. The theoretical cooling efficiency for Yb³⁺ doped β-NaYF₄ crystal at 100 K is about 0.3%. By optimizing the Yb³⁺ dopant concentration, the cooling efficiency of β-NaYF₄:10% Yb³⁺ nanocrystals is predicted to be enhanced by 150%. The theoretical cooling efficiency for β-NaYF₄:10% Yb³⁺ nanocrystals at 100 K is about 0.75%. This is lower than the 2% cooling efficiency of CdS nanobelt at 100 K with 100 nm thickness. However, the cooling efficiency of β-NaYF₄:10% Yb³⁺ nanocrystals is not geometry-restricted compared to CdS nanobelts, which CdS nanobelts have been reported to demonstrate cooling in a thickness range between 65 nm and 120 nm.

It will be readily understood that the embodiments, as generally described herein, are exemplary. The following more detailed description of various embodiments is not intended to limit the scope of the present disclosure, but is merely representative of various embodiments. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified.

While illustrative embodiments have been illustrated and described, it will be appreciated that various changes can be made therein without departing from the spirit and scope of the invention.

The embodiments of the invention in which an exclusive property or privilege is claimed are defined as follows:

1. A crystal comprising yttrium-fluoride doped with a trivalent rare earth ion in the range of 0.5% to 15%, by weight.

2. The crystal of claim 1, wherein the crystal is selected from the group consisting of a yttrium-lithium-fluoride crystal and a yttrium-sodium-fluoride crystal.

3. The crystal of claim 1, wherein the trivalent rare earth ion is selected from the group consisting of Yb³⁺, Er³⁺, and a combination thereof.

4. The crystal of claim 1, wherein the trivalent rare-earth ion is Yb³⁺, thus providing a Yb³⁺ doped yttrium-fluoride crystal.

5. The crystal of claim 1, wherein the trivalent rare-earth ion is Er³⁺, thus providing an Er³⁺ doped yttrium-fluoride crystal.

6. The crystal of claim 5, wherein the crystal comprises Er³⁺ in the range of 1% to 5%, by weight.

7. The crystal of claim 1, wherein the crystal is a yttrium-sodium-fluoride crystal with a hexagonal crystal lattice or a cubic crystal lattice.

8. The crystal of claim 1, wherein the smallest dimension of the crystal is in the range of 100 nm to 1.5 μm.

9. The crystal of claim 1, wherein the crystal is polycrystalline.

10. A method for cooling a solution comprising:
providing a solution comprising a crystal according to claim 1; and
illuminating the solution with photons sufficient to excite an electron in the crystal, thereby emitting a blue-shifted photon and cooling the solution.

11. The method of claim 10, wherein the crystal is selected from the group consisting of a yttrium-lithium-fluoride crystal and a yttrium-sodium-fluoride crystal.

12. The method of claim 10, wherein the crystal is a Yb³⁺ doped yttrium-lithium-fluoride crystal and wherein the illumination is energetically sufficient to excite the E4-E5 resonance of the Yb³⁺ doped yttrium-lithium-fluoride crystal.

13. The method of claim 10, wherein the trivalent rare-earth ion is Yb³⁺, thus providing a Yb³⁺ doped yttrium-fluoride crystal.

14. The method of claim 13, wherein illuminating the solution with photons sufficient to excite an electron in the crystal comprises illuminating with photons having wavelengths of 1020 nm or less.

15. The method of claim 13, wherein the Yb³⁺ doped yttrium-fluoride crystal comprises Yb³⁺ in the range of 0.5% to 15%, by weight.

16. The method of claim 10, wherein the smallest dimension of the crystal is in the range of 100 nm to 1.5 μm.

17. The method of claim 10, wherein the crystal is polycrystalline.

18. The method of claim 10, wherein the crystal further comprises Er³⁺ ions.

19. The method of claim 18, wherein the crystal comprises Er³⁺ in the range of 1% to 5%, by weight.

20. The method of claim 10, wherein the crystal is a yttrium-sodium-fluoride crystal with a hexagonal crystal lattice or a cubic crystal lattice.

21. The method of claim 20, wherein the solution is an aqueous solution.

22. The method of claim 20, wherein the solution is a biological sample.

23. The method of claim 20, wherein the solution is inside a subject.

24. The method of claim 20, wherein a portion of the solution adjacent to the crystal is cooled by about 5° to about 25° C.

25. The method of claim 20, wherein illuminating the solution comprises illuminating the solution with laser light.

26. A method for hydrothermal synthesis of a crystal comprising yttrium-fluoride doped with at least one trivalent rare earth ion, the method comprising:
providing a first solution, comprising a yttrium-containing compound and trivalent rare earth ion dopant precursor selected from the group consisting of a ytterbium-containing compound, an erbium-containing compound, and a combination thereof;
providing a second solution, comprising a fluoride compound selected from the group consisting of lithium fluoride and sodium fluoride; and
mixing and hydrothermally reacting the first solution and the second solution to provide a crystal comprising yttrium-fluoride doped with at least one trivalent rare earth ion.
